(19) United States
(12) Patent Application Publication
(10) Pub. No.: US 2024/0406918 A1
(43) Pub. Date: Dec. 5, 2024

(54) INTERFERENCE MANAGEMENT TECHNIQUES FOR COORDINATED MULTI-RADAR NETWORKS

(71) Applicant: QUALCOMM INCORPORATED, San Diego, CA (US)

(72) Inventors: Preeti Kumari, San Diego, CA (US); Kapil Gulati, Belle Mead, NJ (US); Stelios Stefanatos, San Diego, CA (US); Junyi Li, Greentown, PA (US); Anantharaman Balasubramanian, San Diego, CA (US); Mahmoud Ashour, San Diego, CA (US)

(21) Appl. No.: 18/700,669

(22) PCT Filed: Nov. 9, 2022
(86) PCT No.: PCT/US2022/079527

§ 371 Date: Apr. 11, 2024

(30) Foreign Application Priority Data
Dec. 7, 2021 (GR) 20210100857

(51) Int. Cl. H04W 64/00; H04B 7/06; H04B 17/309; H04W 24/10

(52) U.S. Cl. CPC H04W 64/00; H04B 7/0626; H04B 17/346; H04W 24/10

(57) ABSTRACT

Methods, systems, and devices for wireless communications are described in which interference between wireless devices that employ radar detection may be reduced or mitigated. A user equipment (UE) may transmit radar signals for target detection and collision avoidance in accordance with an interference mitigation procedure. The interference mitigation procedure may be based on measurement reports of different UEs that are transmitted to a first node (e.g., a roadside unit (RSU) or base station). The first node may configure a measurement procedure for multiple UEs that includes multiple measurement stages, in which a first stage provides that a subset of UEs transmit while other UEs measure received radar signals, and a second stage switches the transmitting and measuring UEs. Each of the UEs may provide measurement reports to the first node, which determines coordinated transmit parameters for the UEs to reduce interference among the UEs.

### CROSS REFERENCES

The present Application is a 371 national stage filing of International PCT Application No. PCT/US2022/079527 by KUMARI et al. entitled “INTERFERENCE MANAGEMENT TECHNIQUES FOR COORDINATED MULTI-RADAR NETWORKS,” filed Nov. 9, 2022; and claims priority to Greek Patent Application No. 20210100857 by KUMARI et al. entitled “ACTIVE INTERFERENCE MANAGEMENT FOR COORDINATED MULTI-RADAR NETWORKS,” filed Dec. 7, 2021, each of which is assigned to the assignee hereof, and each of which is expressly incorporated by reference in its entirety herein.

### FIELD OF TECHNOLOGY

The following relates to wireless communications, including interference management techniques for coordinated multi-radar networks.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a wireless device, such as a vehicle UE, may transmit radar signaling to support target detection and collision avoidance. In some cases, a UE may experience interference from radar signals transmitted by neighboring UE(s) or vehicles. For example, a UE may transmit radar signaling and may experience radar interference from one or more other UEs which may result in relatively inaccurate and inefficient target detection.

### SUMMARY

The described techniques relate to improved methods, systems, devices, and apparatuses that support interference management techniques for coordinated multi-radar networks. In accordance with various aspects, the described techniques provide for reducing or mitigating interference between wireless devices that employ radar detection in wireless communications systems having multiple such wireless devices. In some wireless communications systems (e.g., vehicle-to-everything (V2X) systems), a user equipment (UE) may transmit radar signals for target detection and collision avoidance in accordance with an interference mitigation procedure, which may reduce interference caused by neighboring UEs. In some cases, different UEs may transmit measurement reports to management node (e.g., a first node, such as a roadside unit (RSU) or base station), and the management node may provide radar transmission parameters of UEs within proximity of the management node. In some cases, the management node may configure a measurement procedure for multiple UEs that includes multiple measurement stages, in which a first stage provides that a subset of UEs transmit while other UEs measure received radar signals, and a second stage switches the transmitting and measuring UEs. Each of the UEs may provide measurement reports to the management node, which determines coordinated transmit parameters for the UEs to reduce interference among the UEs.

A method for wireless communication at a user equipment (UE) is described. The method may include receiving, from a first node, signaling that indicates a measurement report configuration, the measurement report configuration indicating a first time period during which the UE is to transmit a first radar signal and a second time period during which the UE is to measure one or more received radar signals, transmitting the first radar signal during the first time period based on the measurement report configuration, measuring the one or more received radar signals during the second time period based on the measurement report configuration, and transmitting a measurement report to the first node that includes measurement information for the one or more received radar signals.

An apparatus for wireless communication at a UE is described. The apparatus may include a processor, memory coupled with the processor, and instructions stored in the memory. The instructions may be executable by the processor to cause the apparatus to receive, from a first node, signaling that indicates a measurement report configuration, the measurement report configuration indicating a first time period during which the UE is to transmit a first radar signal and a second time period during which the UE is to measure one or more received radar signals, transmit the first radar signal during the first time period based on the measurement report configuration, measure the one or more received radar signals during the second time period based on the measurement report configuration, and transmit a measurement report to the first node that includes measurement information for the one or more received radar signals.

Another apparatus for wireless communication at a UE is described. The apparatus may include means for receiving, from a first node, signaling that indicates a measurement report configuration, the measurement report configuration indicating a first time period during which the UE is to transmit a first radar signal and a second time period during which the UE is to measure one or more received radar signals, means for transmitting the first radar signal during the first time period based on the measurement report configuration, means for measuring the one or more received radar signals during the second time period based on the measurement report configuration, and means for transmitting a measurement report to the first node that includes measurement information for the one or more received radar signals.

A non-transitory computer-readable medium storing code for wireless communication at a UE is described. The code may include instructions executable by a processor to receive, from a first node, signaling that indicates a measurement report configuration, the measurement report configuration indicating a first time period during which the UE is to transmit a first radar signal and a second time period during which the UE is to measure one or more received radar signals, transmit the first radar signal during the first time period based on the measurement report configuration, measure the one or more received radar signals during the second time period based on the measurement report configuration, and transmit a measurement report to the first node that includes measurement information for the one or more received radar signals.

Some examples of the method, apparatuses, and non-transitory computer-readable medium described herein may further include operations, features, means, or instructions for receiving, from the first node, radar transmit parameters for radar operation at the UE and activating a radar at the UE based on the radar transmit parameters to detect one or more targets in proximity of the UE. In some examples of the method, apparatuses, and non-transitory computer-readable medium described herein, the radar transmit parameters provide for interference mitigation in multi-radar cooperative receive processing.

Some examples of the method, apparatuses, and non-transitory computer-readable medium described herein may further include operations, features, means, or instructions for transmitting, to the first node, an indication of a unique identification of the UE, and one or more of a location, mobility, predicted path, transmit specifications, or performance requirements of the UE. Some examples of the method, apparatuses, and non-transitory computer-readable medium described herein may further include operations, features, means, or instructions for transmitting, to the first node, a request to be included in an active interference management procedure, and an indication of a type of interference information that is requested from the first node.

In some examples of the method, apparatuses, and non-transitory computer-readable medium described herein, the measurement report configuration indicates one or more parameters that are to be measured at the UE, an accuracy of measurements of the one or more parameters, a data format for the measurement report, transmit parameter specifications and space-time-frequency resources to be used for the measuring the one or more received radar signals during the second time period, or any combinations thereof. In some examples of the method, apparatuses, and non-transitory computer-readable medium described herein, the measurement report includes one or more of a unique identification of the UE, a location, a UE mobility, a future behavior or path intent of the UE, a radar specification, a received interference-to-noise ratio, one or more detected scatters in a radar heatmap, a relative interfering radar parameter estimation, or any combinations thereof.

Some examples of the method, apparatuses, and non-transitory computer-readable medium described herein may further include operations, features, means, or instructions for receiving, from the first node, radar transmit parameters that indicate a transmit precoder or beamforming parameters to use in radar transmissions, a frequency-modulated continuous wave (FMCW) radar configuration and delay pattern, one or cooperative sensing parameters, or any combinations thereof and transmitting one or more radar signals from the UE based on the radar transmit parameters.

A method for wireless communication at a first node is described. The method may include determining a measurement configuration for UE measurements for active interference management of a set of multiple radars associated with a set of multiple UEs, transmitting, to a first UE, signaling that indicates the measurement configuration that indicates a first time period during which the first UE is to transmit a first radar signal and a second time period during which the first UE is to measure received radar signals, transmitting, to a second UE, signaling that indicates the measurement configuration, the measurement configuration indicating that the second UE is to transmit a second radar signal in the second time period and measure received radar signals during the first time period, receiving a first measurement report from the first UE and a second measurement report from the second UE, and determining a first set of radar transmit parameters for the first UE and a second set of radar transmit parameters for the second UE.

An apparatus for wireless communication at a first node is described. The apparatus may include a processor, memory coupled with the processor, and instructions stored in the memory. The instructions may be executable by the processor to cause the apparatus to determine a measurement configuration for UE measurements for active interference management of a set of multiple radars associated with a set of multiple UEs, transmit, to a first UE, signaling that indicates the measurement configuration that indicates a first time period during which the first UE is to transmit a first radar signal and a second time period during which the first UE is to measure received radar signals, transmit, to a second UE, signaling that indicates the measurement configuration, the measurement configuration indicating that the second UE is to transmit a second radar signal in the second time period and measure received radar signals during the first time period, receive a first measurement report from the first UE and a second measurement report from the second UE, and determine a first set of radar transmit parameters for the first UE and a second set of radar transmit parameters for the second UE.

Another apparatus for wireless communication at a first node is described. The apparatus may include means for determining a measurement configuration for UE measurements for active interference management of a set of multiple radars associated with a set of multiple UEs, means for transmitting, to a first UE, signaling that indicates the measurement configuration that indicates a first time period during which the first UE is to transmit a first radar signal and a second time period during which the first UE is to measure received radar signals, means for transmitting, to a second UE, signaling that indicates the measurement configuration, the measurement configuration indicating that the second UE is to transmit a second radar signal in the second time period and measure received radar signals during the first time period, means for receiving a first measurement report from the first UE and a second measurement report from the second UE, and means for determining a first set of radar transmit parameters for the first UE and a second set of radar transmit parameters for the second UE.

A non-transitory computer-readable medium storing code for wireless communication at a first node is described. The code may include instructions executable by a processor to determine a measurement configuration for UE measurements for active interference management of a set of multiple radars associated with a set of multiple UEs, transmit, to a first UE, signaling that indicates the measurement configuration that indicates a first time period during which the first UE is to transmit a first radar signal and a second time period during which the first UE is to measure received radar signals, transmit, to a second UE, signaling that indicates the measurement configuration, the measurement configuration indicating that the second UE is to transmit a second radar signal in the second time period and measure received radar signals during the first time period, receive a first measurement report from the first UE and a second measurement report from the second UE, and determine a first set of radar transmit parameters for the first UE and a second set of radar transmit parameters for the second UE.

Some examples of the method, apparatuses, and non-transitory computer-readable medium described herein may further include operations, features, means, or instructions for transmitting the first set of radar transmit parameters to the first UE and the second set of radar transmit parameters to the second UE, where the radar transmit parameters provide for interference mitigation in multi-radar cooperative receive processing. In some examples of the method, apparatuses, and non-transitory computer-readable medium described herein, the radar transmit parameters include one or more of a space-time-frequency resource allocation, a transmit precoder, a waveform parameter selection, cooperative sensing and receive processing parameters, or any combinations thereof.

Some examples of the method, apparatuses, and non-transitory computer-readable medium described herein may further include operations, features, means, or instructions for receiving, from each of the first UE and the second UE, an indication of a unique identification, and one or more of a location, mobility, predicted path, transmit specifications, or performance requirements of the associated UE. Some examples of the method, apparatuses, and non-transitory computer-readable medium described herein may further include operations, features, means, or instructions for receiving from each of the first UE and the second UE, a request to be included in active interference management procedures of the first node, and an indication of a type of interference information that is requested.

Some examples of the method, apparatuses, and non-transitory computer-readable medium described herein may further include operations, features, means, or instructions for determining, based on radar specifications and receive requirements of the set of multiple radars associated with the set of multiple UEs, whether to implement coordinated interference management to perform an active interference management procedure or a passive interference management procedure, and where the determining the measurement configuration is performed responsive to determining to implement the active interference management procedure. In some examples of the method, apparatuses, and non-transitory computer-readable medium described herein, the passive interference management procedure provides time resources and radar transmit parameters for the set of multiple UEs in an absence of measurement reports from the set of multiple UEs. In some examples of the method, apparatuses, and non-transitory computer-readable medium described herein, the interference management procedure includes a determination of a multi-radar configuration for active radar measurements within a cluster of UEs. In some examples of the method, apparatuses, and non-transitory computer-readable medium described herein, the passive interference management procedure may be implemented based on a congestion level of the set of multiple UEs being below a threshold value, and the active interference management procedure may be implemented based on a congestion level of the set of multiple UEs being at or above the threshold value.

In some examples of the method, apparatuses, and non-transitory computer-readable medium described herein, the first measurement report and the second measurement report each include one or more of a unique identification of the associated UE, a location, a UE mobility, a future behavior or path intent of the associated UE, a radar specification, a received interference-to-noise ratio, one or more detected scatters in a radar heatmap, a relative interfering radar parameter estimation, or any combinations thereof. In some examples of the method, apparatuses, and non-transitory computer-readable medium described herein, the measurement configuration indicates one or more measurement report parameters and an associated accuracy, a measurement report data format, one or more transmit parameters and space-time-frequency resources to be used while performing measurements, or any combinations thereof. In some examples of the method, apparatuses, and non-transitory computer-readable medium described herein, the first set of radar transmit parameters and the second set of radar transmit parameters each include an associated time period for use at a corresponding UE.

In some examples of the method, apparatuses, and non-transitory computer-readable medium described herein, the first measurement report and the second measurement report include one or more of a global channel state information (CSI) and interference profile estimate in a range-angle-Doppler domain, a local CSI and interference profile estimate in the range-angle-Doppler domain, a congestion measurement, one or more clutter statistics, a location relative to the first node, a mobility of the associated UE, or any combinations thereof, that may be used to determine a prediction of each UE in a cluster of UEs, relative radar transmit parameters, tracking and prediction of one or more scatterers in proximity of one or more UEs, or any combinations thereof. In some examples of the method, apparatuses, and non-transitory computer-readable medium described herein, the first set of radar transmit parameters and the second set of radar transmit parameters each indicate a transmit precoder or beamforming parameters to use in radar transmissions, a frequency-modulated continuous wave (FMCW) radar configuration and delay pattern, one or cooperative sensing parameters, or any combinations thereof.

### BRIEF DESCRIPTION OF THE DRAWINGS

FIG. 1 illustrates an example of a wireless communications system that supports interference management techniques for coordinated multi-radar networks in accordance with aspects of the present disclosure.

FIGS. 2 and 3 illustrate examples of wireless communications system that support interference management techniques for coordinated multi-radar networks in accordance with aspects of the present disclosure.

FIGS. 4A through 4C illustrate an example of a measurement procedure that supports interference management techniques for coordinated multi-radar networks in accordance with aspects of the present disclosure.

FIG. 5 illustrates an example of a process flow that supports interference management techniques for coordinated multi-radar networks in accordance with aspects of the present disclosure.

FIGS. 6 and 7 show block diagrams of devices that support interference management techniques for coordinated multi-radar networks in accordance with aspects of the present disclosure.

FIG. 8 shows a block diagram of a communications manager that supports interference management techniques for coordinated multi-radar networks in accordance with aspects of the present disclosure.

FIG. 9 shows a diagram of a system including a device that supports interference management techniques for coordinated multi-radar networks in accordance with aspects of the present disclosure.

FIGS. 10 and 11 show block diagrams of devices that support interference management techniques for coordinated multi-radar networks in accordance with aspects of the present disclosure.

FIG. 12 shows a block diagram of a communications manager that supports interference management techniques for coordinated multi-radar networks in accordance with aspects of the present disclosure.

FIG. 13 shows a diagram of a system including a device that supports interference management techniques for coordinated multi-radar networks in accordance with aspects of the present disclosure.

FIGS. 14 through 17 show flowcharts illustrating methods that support

interference management techniques for coordinated multi-radar networks in accordance with aspects of the present disclosure.

### DETAILED DESCRIPTION

In some wireless communications systems, radio frequency signaling, such as radar signaling, (e.g., Frequency Modulated Continuous Wave (FMCW) radar, Phase Modulated Continuous Wave (PMCW) radar, or the like) may be implemented in a wide range of applications including vehicle ranging for target detection. In some examples, radar signaling may be employed by a user equipment (UE) such as a vehicle UE. For example, the vehicle UE may transmit radar signaling to detect potential targets and avoid collisions with the detected target. In some cases, other vehicle UEs in the vicinity of the UE (e.g., neighboring UEs) may also transmit radar signaling which may potentially cause interference that may obscure or overwhelm radar reflected from a target and may not include identifying features, preventing the UE from efficiently discerning interference and identifying the target and its location.

In some examples, radar signaling from a neighboring UE may interfere with radar reflected from a target (e.g., that was originally transmitted by the UE) which may result in relatively inaccurate and inefficient target detection. In some examples, interference from the neighboring UE may be detected by the UE and may be incorrectly identified as a target (e.g., a ghost target) which may cause the UE to perform operations or measures (e.g., preventative measures) which in turn may cause undesirable or ineffective operations. For example, the UE may maneuver to avoid a ghost target and as a result may encounter an undetected target which was obscured by interference. In some examples, interference from the neighboring UE may cause the UE to experience a high level of noise (e.g., may increase a noise floor) based on radar waveforms transmitted by the UE, which may obscure reflected signaling from a target, for example. In some examples, power received from radar signaling reflected by a target may decay (e.g., decrease in received power at the UE) more quickly than interference from a neighboring UE which may also cause obfuscation of radar reflected from potential targets. In some such examples, interference from the neighboring UE may cause a reduction in the range of radar transmissions of the UE, thereby decreasing the accuracy of target detection and collision avoidance at the UE. Thus, the UE may not detect some radar signaling (e.g., radar signaling reflected by a target), when the UE experiences interference from neighboring UEs.

Various techniques described herein may reduce or mitigate the effects of radar signaling interference, which may, for example, be caused by neighboring UEs or other devices transmitting radar signals. In some cases, passive interference management techniques may be implemented, in which a management node (e.g., a first node which may be a roadside unit (RSU) or base station) may signal to vehicles, in a certain area, radar transmission parameters, which can provide different time periods for radar transmissions of different vehicles. Further, in some cases in which congestion may be relatively high, active interference management may be implemented to provide additional control over particular transmitters to prevent collisions/interference in radar transmissions. In some cases, active interference management techniques may provide that different UEs transmit measurement reports to a management node (e.g., RSU, base station, or other management node) and the management node provides radar transmission parameters to UEs within proximity of the management node. In some cases, the management node may configure a measurement procedure for multiple UEs, in which a first stage of the measurement procedure provides that a first subset of UEs transmit while other UEs of a second subset of UEs measure received radar signals. A second stage of the measurement procedure may provide that the second subset of UEs transmit while the first subset of UEs measure received radar signals. Each of the UEs may provide measurement reports to the management node, which may determine coordinated transmit parameters for the UEs to reduce interference among the UEs. The coordinated transmit parameters may be provided to the UEs in a third stage of the measurement procedure, and the UEs may operate in accordance with the coordinated transmit parameters to reduce or mitigate interference from other radar signaling from other sources or devices (e.g., neighboring UEs).

By coordinating the radar transmission parameters with the management node (e.g., a first node such as a RSU or base station), the UE may reduce its exposure to interference and may reduce interference in the wireless communications system overall (e.g., with respect to neighboring UEs). For example, the UE may transmit radar signaling using the determined set of transmission parameters which may result in reduced interference at the UE and at other neighboring UEs. Accordingly, UEs may efficiently detect targets and avoid collisions, enhance overall safety, and enhance system reliability, among other benefits.

Aspects of the disclosure are initially described in the context of wireless communications systems. Aspects of the disclosure are further illustrated by and described with reference to measurement procedures, a process flow, apparatus diagrams, system diagrams, and flowcharts that relate to interference management techniques for coordinated multi-radar networks.

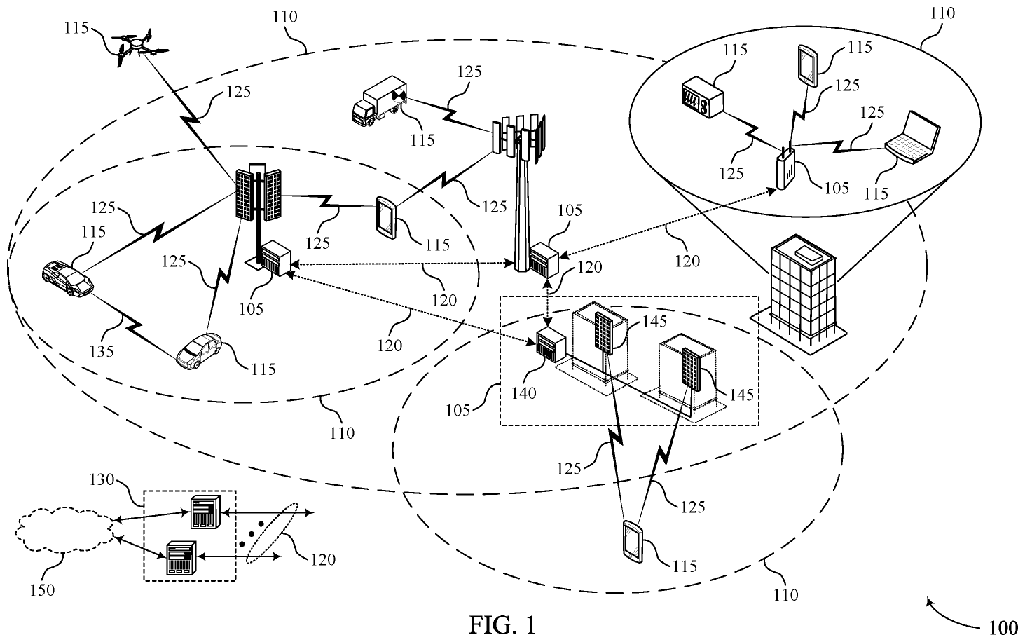

FIG. 1 illustrates an example of a wireless communications system 100 that supports interference management techniques for coordinated multi-radar networks in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHZ industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, a UE 115 may transmit radar signaling in a wide range of applications including vehicle ranging for target detection in a V2X system, and the like. In some cases, such UEs 115 may transmit radar signals in accordance with an interference mitigation procedure, which may reduce interference caused by neighboring UEs 115. In some cases, different UEs 115 may transmit measurement reports to management node (e.g., a first node, such as a RSU or base station 105), and the management node may provide radar transmission parameters of UEs 115 within proximity of the management node. In some cases, the management node may configure a measurement procedure for multiple UEs 115 that includes multiple measurement stages, in which a first stage provides that a subset of UEs 115 transmit while other UEs 115 measure received radar signals, and a second stage switches the transmitting and measuring UEs 115. Each of the UEs 115 may provide measurement reports to the management node, which determines coordinated transmit parameters for the UEs 115 to reduce interference.

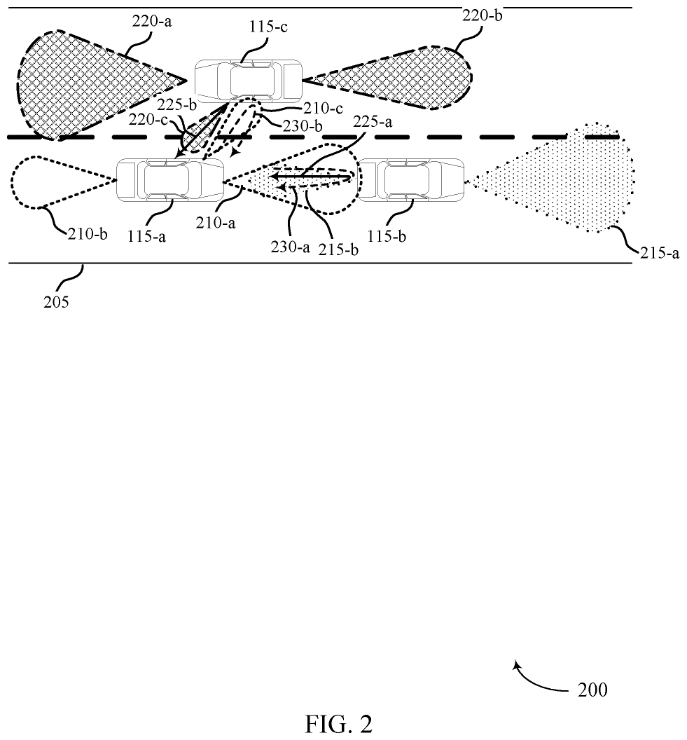

FIG. 2 illustrates an example of a wireless communications system 200 that supports interference management techniques for coordinated multi-radar networks in accordance with aspects of the present disclosure. In some examples, wireless communications system 200 may implement aspects of the wireless communications system 100. For example, UEs 115 operating in the wireless communications system 200 may experience interference between radar signaling such as due to other UEs 115, a direction of motion, and a geometry of a roadway 205 within the wireless communications system 200. The wireless communications system 200 may include one or more vehicles (e.g., a UE 115-a, a UE 115-b, a UE 115-c, which may be examples of UEs 115 as described with reference to FIG. 1) that may travel in various directions or lanes within the roadway 205. The UEs 115-a, 115-b, and 115-c may support interference management based on coordinated radar transmission parameters for multi-radar coexistence in accordance with aspects of the present disclosure.

In the example of FIG. 2, Each of UE 115-a, 115-b, and 115-c may include one or more radar transmitters which may transmit long-range radar (LRR), mid-range radar (MRR), or short range radar (SRR). For example, a transmitter on a frontside of a vehicle may transmit LRR, a transmitter on a backside of a vehicle may transmit MRR while a transmitter on a left or right side of a vehicle UE 115 may transmit SRR. In some examples, a first UE 115-a may transmit radar signaling 210-a (e.g., LRR), radar signaling 210-b (e.g., MRR), and radar signaling 210-c (e.g., SRR) to support various functionalities of the UE 115-a (e.g., target tracking for environmental and object detection, among other examples) while in operation. A second UE 115-b may transmit radar signaling 215 (e.g., LRR radar signaling 215-a and MRR radar signaling 215-b), and a third UE 115-c may transmit radar signaling 220 (e.g., LRR radar signaling 220-a, MRR radar signaling 220-b, and SRR radar signaling 220-c.) while traveling in an opposite direction of the first UE 115-a and second UE 115-b. Based on the local geometry of the roadway 205 and proximity of UEs 115, this example may be an area of high interference levels between radar signals. For example, the radar signaling 210-a may interact with the radar signaling 215-b, which may cause direct interference 225-a in a first reflected radar 230-a received by the first UE 115-a. Likewise, the radar signaling 210-c may interact with the radar signaling 220-c of the third UE 115-c, which may cause direct interference 225-b in a second reflected radar 230-b received by the first UE 115-a.

In some cases, the radar signaling 210, 215, and 220 may be radar signaling such as FMCW radar signaling or PMCW radar signaling, which may enable the UEs 115 with various functionalities (e.g., ranging, environmental and object detection, among other examples). In some cases, interfering sources (e.g., from second radar signal 215-b) may appear to the first UE 115-a as a target with an inaccurate position (e.g., a ghost target) or may result in the UE 115-a detecting an increased amount of noise which may also contribute to a decreased tracking range at the UE 115-a.

For example, the first UE 115-a may transmit radar signaling 210-a to perform target detection and tracking. In such cases, the first UE 115-a may transmit the radar signaling 210-a (e.g., a LRR radar signal) which may be reflected by the second UE 115-b in first reflected radar 230-a. The first UE 115-a may receive the first reflected radar 230-a and may generate an image of a target corresponding to second UE 115-b, including information about its position with respect to the first UE 115-a. The first UE 115-a may determine an association between the detected radar image and the target. For example, first UE 115-a may map the radar detections to the tracked target to generate continuous tracking data for the target. The first UE 115-a may be likely to experience error in radar detection operations (e.g., mis-detecting the target, false alarm detection, mistaking a new target for the tracked target, among other possibilities) and may include the likelihood of such errors in the association between the radar image and the target. Increased noise may contribute to a significant reduction in the tracking range of the first UE 115-a, making it less sensitive overall to signal detection. In some cases, the interfering source may be much stronger than the reflected radar 230-a signal, obscuring the reflected radar signal 230-a as the first UE 115-a detects both signals. The result of interfering radar sources at the first UE 115-a may vary depending on the radar waveforms used. Signal interference may degrade ranging accuracy and object detection.

In some cases, an uncoordinated approach to interference mitigation (e.g., no communication between radars) may provide that each radar operates independently with no exchange of information between them. In such an approach, each radar choses its own transmit parameters to the mitigate interference effect, such as through reactively selecting parameters based on the local interference measurement when receiving signals, through random transmit parameters (e.g., slope or timing offset in FMCW waveforms), through uncoordinated radar mitigation techniques at receiver radars (e.g., omission or repair techniques on the portion of received radar signal where the interference effect is detected). Such uncoordinated mitigation results in some amount of interference that remains, which may be acceptable in some situations (e.g., relatively few targets and interferers, low congestion, etc.).

In other cases, one or more passive interference management techniques may be implemented, in which coordinated radars announce their transmission parameters and sensor capabilities. Based on these messages, transmit configuration parameters for the multi-radar network is jointly selected to minimize or even eliminate interference passively. Passive coordinated approaches includes orthogonal and non-orthogonal approaches based on radar codebooks, for example. In orthogonal passive approaches, the transmit resources may be allocated in separate polarization, time interval, frequency band, different coding, and field of view (FoV) or orientation. In non-orthogonal passive approaches, the transmit parameters may be selected such that the receive processing can be leveraged to avoid or mitigate interference. For example, mutually interfering radars in an area may transmit a same FMCW waveform (i.e., with common FMCW waveforms, the effect of interference is generation of “ghost” targets at the victim radar side), and apply independent delays may be applied prior the start of a new frame, effectively introducing an artificial time offset among frames transmitted by different radars. With frame offsets changing in a pseudo-random fashion, the ghost target range (position) appears as “hopping” in an unrealistic fashion between successive frames, and filtering or tracking of detected targets across frames may be used to discard most of the ghost targets as false alarms as they correspond to a non-realistic movement. Such passive interference mitigation may help to reduce interference relative to uncoordinated techniques, and may also result in some amount of interference, which may be acceptable in some situations (e.g., relatively few targets and interferers, low congestion, etc.).

In cases where passive interference mitigation is used, in some cases, there may be blockage between two radars, which may reduce the interference or even eliminate it. However, passive interference management may unnecessarily allocate orthogonal resources to these radars instead of reusing the same resource among them, and the underutilization of space-time-frequency resources may be limiting in a highly congested and dynamic environment. In cases where passive coordinated interference management is used, orthogonal waveforms may rely on all mutually interfering radars to transmit signals with parameters chosen from a discrete codebook. Such techniques may be effective in mitigating interference, but may limit the number of maximum radars that can be cooperated using this scheme due to a finite size of the discrete codebook. In some cases, non-orthogonal transmissions may provide that different radars are assigned a specific FMCW waveform configuration with independent delays applied to each new frame. Such techniques again may be effective, but may be limited in high congestion areas due to the choice of delays for each radars within a specific waveform configuration, as well as the choice of a specific FMCW waveform configuration for managing interference to meet a minimum radar performance requirement, might get exhausted. Further, even after applying passive coordinated approach, radar interference may still be a limiting factor due to poor situational awareness, lack of accurate interference, limited interfering radar parameter knowledge (relative to the transmitting radar (e.g., ego vehicle) with poor synchronization), and channel state information measurements in a highly dynamic and congested vehicular environment.

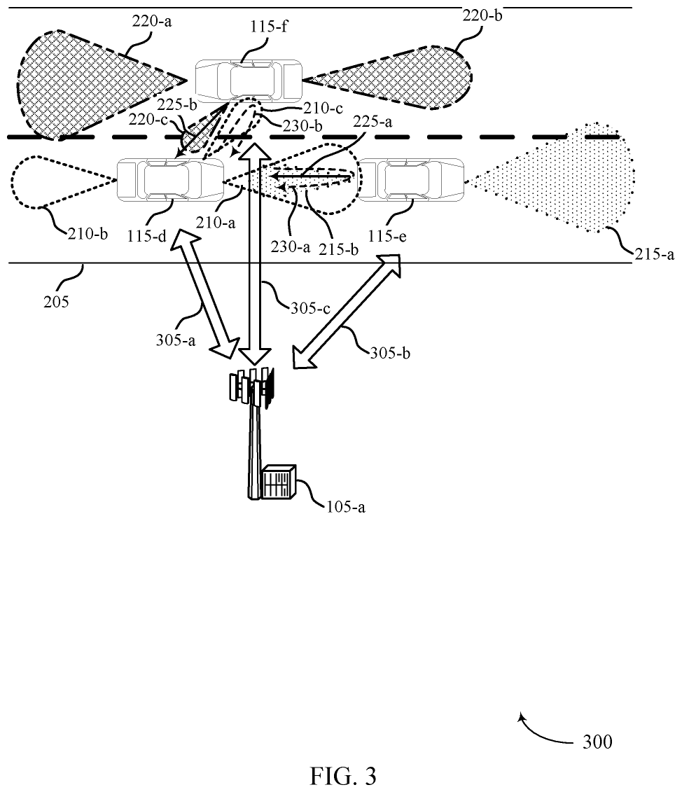

In some cases, such as discussed in more detail with reference to FIGS. 3 through 5, techniques described herein support active interference management, and may result in decreased interference at the first UE 115-a, and other UEs 115 that transmit radar signals. Such techniques may be used, in some cases, in conjunction with uncoordinated or passive interference mitigation based on operating conditions (e.g., an amount of interference, congestion, etc.), and a mitigation technique may be selected for one or more groups or clusters of UEs based on operating conditions, which may provide for mitigation of interference for coordinated multi-radar networks by gathering and exploiting dynamic RF measurement reports to enable enhanced coordinated radar performance in vehicular environments.

FIG. 3 illustrates an example of a wireless communications system 300 that supports interference management techniques for coordinated multi-radar networks in accordance with aspects of the present disclosure. In some examples, the wireless communications system 300 may implement aspects of the wireless communications systems 100 or 200. For instance, the wireless communications system 300 includes first UE 115-d, second UE 115-e, and third UE 115-f, which may be examples of UEs 115 as described with reference to FIGS. 1 and 2. The wireless communications system 300 also includes a base station 105-a, which may be an example of a base station 105 as described with reference to FIG. 1, or a RSU or management node as discussed herein. In some examples, the wireless communications system 300 may implement communications using radar transmission parameters to reduce interference from other nearby radar sources.

In the example of FIG. 3, similarly as discussed with reference to the example of FIG. 2, each of UE 115-d, 115-e, and 115-f may include one or more radar transmitters which may transmit LRR, MRR, or SRR, and first UE 115-d again may transmit radar signaling 210-a (e.g., LRR), radar signaling 210-b (e.g., MRR), and radar signaling 210-c (e.g., SRR) to support various functionalities of the first UE 115-d (e.g., target tracking for environmental and object detection, among other examples) while in operation. Likewise, the second UE 115-e may transmit radar signaling 215 (e.g., LRR radar signaling 215-a and MRR radar signaling 215-b), and a third UE 115-f may transmit radar signaling 220 (e.g., LRR radar signaling 220-a, MRR radar signaling 220-b, and SRR radar signaling 220-c.), similarly as discussed in the example of FIG. 2. Based on the local geometry of the roadway 205 and proximity of UEs 115, this example may be an area of high interference levels between radar signals. For example, the radar signaling 210-a may interact with the radar signaling 215-b, which may cause direct interference 225-a in a first reflected radar 230-a received by the first UE 115-d. Likewise, the radar signaling 210-c may interact with the radar signaling 220-c of the third UE 115-f, which may cause direct interference 225-b in a second reflected radar 230-b received by the first UE 115-d. In this example, the base station 105-a may coordinate active interference mitigation of UEs 115.

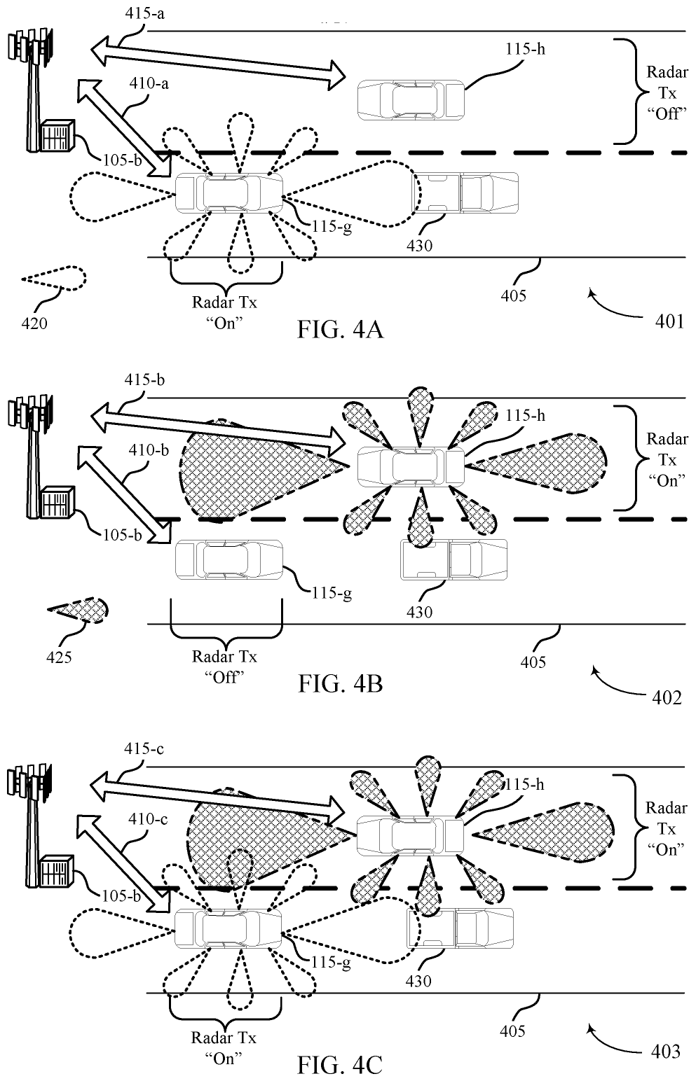

In this example, the base station 105-a, which in some cases may be a RSU or management node, has communication links 305 with UEs 115, including first communication link 305-a with first UE 115-d, second communication link 305-b with second UE 115-e, and third communication link 305-c with third UE 115-f. Communications links 305 may provide signaling for active interference management techniques for a coordinated multi-radar network, as discussed herein. In some cases, the base station 105-a may receive and leverage dynamic RF measurement reports for each pair of ego-interfering radars within a specific cluster of coordinated radars. In some cases, the base station 105-a may configure UEs 115 for measurement procedures in multiple measurement report stages, where only one transmitter is kept on (e.g., orthogonal in space-time-frequency grid) to collect active measurement reports (monostatic and bistatic) from one or more the radar receivers. These measurement reports may include, for example, interference-to-noise ratio, dynamic CSI, situational awareness, and the interfering radar (location and transmit) parameters relative to the ego vehicle. The active interference measurement report can be used to jointly enhance radar transmit parameters to enable enhanced interference mitigation, and to enable enhanced cooperative multi-radar receive processing. The active interference measurement report in a highly dynamic vehicular environment can be leveraged for improved radar sensing performance such as, for example, for one or more of: enhanced space-time-frequency resource allocation; improved transmit precoder/beamformer design, and waveform parameter selection for better interference avoidance and suppression; enhanced receive processing to mitigate interference effect; or enabling enhanced cooperative sensing. An example of measurement stages of some examples is discussed with reference to FIGS. 4A through 4C.

FIGS. 4A through 4C illustrate an example of measurement techniques 401, 402, and 403 that support interference management techniques for coordinated multi-radar networks in accordance with aspects of the present disclosure. In some examples, measurement techniques 401, 402, and 403 may implement or be implemented by aspects of the wireless communications systems 100, 200, or 300. For instance, first UE 115-g and a second UE 115-h may communicate with a base station 105-b (which may be an example of a RSU and is referred to as a RSU in this example) via respective first communication link 410-a and second communication link 415-a. In this example, a target 430 may be present on a roadway 405 and in proximity of first UE 115-g and second UE 115-h.

In this example, a first measurement stage is illustrated in FIG. 4A, in which the first UE 115-g has one or more radars in an on state to transmit radar signals 420. During this first measurement stage, the second UE 115-h may have its radar(s) off, and may measure received signals and transmit a measurement report to the RSU via second communication link 415-a. A second measurement stage is illustrated in FIG. 4B, in which the second UE 115-h has one or more radars in an on state to transmit radar signals 425 in accordance with parameters provided by the RSU in second communication link 415-b. During this second measurement stage, the first UE 115-g may have its radar(s) off, and may measure received signals and transmit a measurement report to the RSU via first communication link 410-b. In a third stage, as illustrated in FIG. 4C, the first UE 115-g and the second UE 115-h may activate and deactivate their radar(s) in accordance with parameters provided by the RSU in first communication link 410-c and second communication link 415-c.

In some cases, a radar (e.g., one or more radars at the first UE 115-g and second UE 115-h) may announces its sensor/vehicle unique ID, location, mobility, predicted behavior/path, transmit specifications and performance requirements to the RSU. In some cases, each radar may also send a signal to indicate whether it would like to be included in the active interference management procedures and what aggregated measurement report or information it would like the RSU to share with it. In some cases, the measurement procedures of FIGS. 4A through 4C may be periodic or event-triggered (e.g., triggered by RSU or vehicles based on poor radar performance and interference detection or when entering RSU control-area, such as a coverage area of the RSU). The RSU, based on the received radar specifications and received measurement report/information details, the RSU may determine whether coordinated multi-radar interference management technique is appropriate (e.g., based on a congestion of a radar cluster/group). If needed, the RSU may determine whether an active or passive interference management technique is to be employed. For passive management, RSU allocates resources and specifies radar transmit parameters within a zone. For active interference management, the RSU may first determine a multi-radar configuration for active RF measurements within a cluster of radar-mounted vehicle nodes. The RSU may transmit signals to vehicle UEs 115 in the specific cluster/group (e.g., UEs 115 within a particular area or cluster and within a coverage area of the RSU) to collect active measurement reports (e.g., measurement configuration information that specifies what parameters to measure and with how much accuracy; and may also specify a data format for sending back the measurement report) along with transmit parameter specifications and space-time-frequency resources to be used while performing these measurements.

Each vehicle UE 115 may receive the RSU request (e.g., periodic or event-triggered), and one vehicle (e.g., first vehicle UE 115-a as illustrated in FIG. 4A) may transmit radar signal(s) (e.g., only a subset of transmitters are “on”) in accordance with the RSU instructed configuration, while the co-located and/or remote radar receivers collect the direct and reflected signals. In the second measurement stage, other vehicles may transmit radar signal(s), which are measured at vehicles that transmitted during the first measurement stage, as illustrated in FIG. 4B. The multi-radar receivers send back active measurement reports to the RSU for each of the vehicle UEs 115 in the specific cluster. The RSU, upon receiving interference measurement reports from the vehicle UEs 115 from the specific cluster, may extract relevant interference and channel parameters for enhanced transmit precoder/beamformer design, enhanced cooperative receive processing, enhanced transmit waveform parameter selection, or any combinations thereof, for all the vehicle UEs 115 in the specific cluster. The RSU communicates the determined transmit parameters to the vehicle UEs 115 in the specific cluster/group. In some cases, the RSU may also send back relevant aggregated measurement data to the interested vehicle UEs 115 (e.g., the vehicle(s) that requested reports back from the RSU).

The vehicle UEs 115 may receive the RSU messages related to radar transmit parameters, and the associated radars may transmit with updated parameters and performs coordinated radar sensing by leveraging aggregated RSU measurement reports (e.g., apriori receive processing, such as CSIR). In some cases, the RSU messages may be used at the vehicle UEs 115 for a certain period (e.g., that is configured or otherwise indicated by the RSU), such as when a vehicle UE 115 exits a control area of the RSU or when congestion/interference is low or below a configured threshold value.

As discussed, in some cases, the RSU may receive radar specifications and receive requirement details, and may determine whether a coordinated multi-radar active interference management technique is needed. If needed, the RSU may determine whether active or passive interference management technique is to be employed. For passive management, the RSU may allocate resources and specify radar transmit parameters within a zone (e.g., within a control area or coverage area associated with the RSU). For active interference management, the RSU may first determine multi-radar configuration for active RF measurements within a cluster of radar-mounted vehicle nodes (e.g., within the control area of the RSU).

In some cases, the RSU may determine whether any RSU-assisted interference management is needed based on one or more of a congestion metric (e.g., a static or semi-static metric based on location and timing, or a dynamic metric based on interference measurement reports), radar specifications and performance requirements (e.g., a minimum detection and false alarm rate performance), or any combinations thereof. If interference management is needed, the RSU may determine which interference management type to be used. For example, passive management may be selected when congestion is low, as it requires lower signaling overhead, and active management may be selected for optimal resource allocation in high congestion as well as complex, dynamic and highly mobile vehicular environments. Further, in some cases active management may be selected if passive interference management leads to poor interference mitigation and limited coordinated multi-radar performance (e.g., which may be determined without invoking passive interference management by first order calculations, or after invoking passive interference management and noticing undesirable coordinated multi-radar performance). In other cases, active management may also be used when specifically requested by the vehicle UEs 115 or event-triggered by vehicles or RSU for enhanced coordinated multi-radar detection and estimation performance, as well as reduced power consumption.

In some cases, the coordinated transmit parameters may be determined based on active interference measurement reports from each UE 115, that can be used to jointly determine radar transmit parameters to enable enhanced interference mitigation and to enable enhanced cooperative multi-radar receive processing. The active interference measurement report in a highly dynamic vehicular environments can be leveraged for improved radar sensing performance to provide, for example, enhanced space-time-frequency resource allocation, improved transmit precoder/beamformer design, and waveform parameter selection for better interference avoidance and suppression, enhanced receive processing to mitigate interference effect, enablement of enhanced cooperative sensing, or any combinations thereof. In some cases, the active measurement reports may include one or more of a unique ID of vehicle; a location, mobility, future behavior/path intent of the vehicle; vehicle radar specifications; a received interference-to-noise ratio; detected scatters parameters in the radar heatmap; or relative interfering radar parameter estimation. In some cases, the vehicle radar specifications may include, for example, one or more of a type of waveform (e.g., FMCW, PMCW, or joint communication-radar waveform (e.g., OFDM-based radar waveform)); a waveform specific configuration (e.g., for FMCW; chirp rate, upchirp duration); a start and stop frequency, frame duration, and number of frames in a coherent processing interval; a unique ID of a radar and location of radar on the vehicle; beamforming parameters (e.g., gain and shape), which may be codebook based; a duty cycle, update rate, transmission power; a placement and orientation of sensors on vehicles; a sensor capability (e.g., maximum detection distance, velocity, and angle); or a minimum detection/estimation performance requirement. In some cases, the detected scatterers parameters in the radar heatmap may include an average and spread of scattering clusters in the delay-angle-Doppler domain, or an amplitude (e.g., where one or multiple scattering clusters could correspond to an interfering vehicle). In some cases, the relative interfering radar parameter estimation may include one or more of relative location and velocity parameters, or relative transmit parameters.

In some cases, a vehicle UE 115 may receive a request from the RSU (e.g., periodic or event-triggered), and each radar may send a transmit signal (e.g., only one transmitter or a subset of transmitters is “on”) in accordance with the RSU instructed specifications, while the co-located and/or remote radar receivers collect the direct and reflected signals. The multi-radar receivers may transmit back active measurement reports to the RSU for each of the vehicle in the specific cluster. In some cases, a specific cluster includes radars that have requested or accepted a request to participate in active interference measurement. Additional criteria may be used in some cases to select the radars in this specific group, such as the RSU predicting high congestion or incoming of priority vehicles, or location based (e.g., highly cluttered and metallic surrounding, such as tunnels). Further, there may be one or multiple specific clusters within the RSU control area that do not interfere with each significantly. Based on the active measurement reports from UEs 115 from the specific cluster, the RSU may extract one or more of the following parameters: a global channel state information (CSI) and interference profile estimate in range-angle-Doppler domain; local CSI and interference profile estimates for each radar in the group in range-angle-Doppler domain; a congestion measure; clutter statistics and instantaneous profile; a relative location, mobility, and prediction of each of the vehicles in the cluster with high accuracy; relative radar transmit parameters; or tracking and prediction of critical scatterers (e.g., that cause or could cause significant interference).

In some cases, the RSU may receive the interference measurement reports from all the vehicle UEs 115 from the specific cluster, and extracts relevant interference and channel parameters for enhanced transmit precoder design, enhanced cooperative receive processing, enhanced transmit waveform parameter selection, and cooperative sensing for the vehicle UEs 115 in the specific cluster. The RSU may communicate the determined transmit parameters to the vehicle UEs 115 in the specific group. The RSU may also send relevant aggregated measurement data to the interested vehicle UEs 115 (e.g., to vehicles that requested to receive those reports back from the RSU). In some cases, the transmit parameters may include enhanced transmit precoder/beamformer parameters that avoid interference (e.g., with obtained CSI at the transmitter (CSIT) and interference profile). The transmit parameters may also provide enhanced receive processing with obtained interfered CSI at the receiver (CSIR), clutter information, and interference profile (e.g., based on successive interference cancellation). In some cases, the transmit parameters may include a FMCW configuration and delay pattern for coordinative interference (e.g., based on V2X-based FMCW radar coordination, based on GPS location parameters, or combinations thereof). In some cases, the delay pattern may be enhanced using highly accurate location and mobility parameters obtained using interference measurement reports. Additionally, or alternatively, cooperative sensing may be implemented in which highly accurate global and local CSI along with accurate knowledge of remote radar sensing (e.g., transmit parameters) and location/mobility parameters can also be exploited.

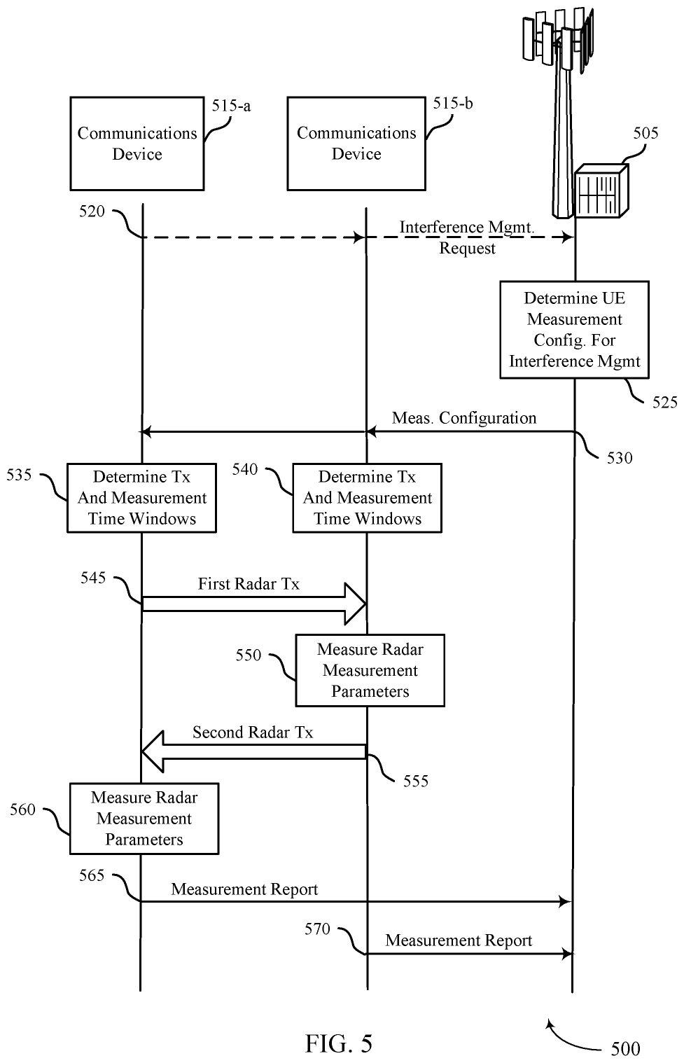

FIG. 5 illustrates an example of a process flow 500 that supports interference management techniques for coordinated multi-radar networks in accordance with aspects of the present disclosure. In some examples, the process flow 500 may implement aspects of wireless communications systems of FIGS. 1 through 4C. Process flow 500 includes a first communications device 515-a (e.g., a first UE), a second communications device 515 (e.g., a second UE), and a base station 505, which may be examples of the corresponding devices as described with reference to FIGS. 1 through 4C. In some examples, the base station 505 may be an example of a RSU or a management node.

In the following description of the process flow 500, the operations between the communications devices 515 and the base station 505 may be transmitted in a different order than the exemplary order shown, or operations performed by the communications devices 515 and the base station 505 may be performed in different orders or at different times. Certain operations may also be left out of the process flow 500, or other operations may be added to the process flow 500. It is to be understood that while the communications devices 515 and the base station 505 are shown performing a number of the operations of process flow 500, any wireless device may perform the operations shown. Process flow 500 may illustrate selecting radar transmission parameters for multi-radar coexistence.

At 520, the first communications device 515-a, the second communications device 515, or both, may optionally transmit an interference management request to the base station 505. In some cases, the interference management request may be transmitted in uplink control information, V2X control information, in a MAC control element (MAC-CE), in RRC signaling, or any combinations thereof, and may include a request to be included in an active interference management procedure. In some cases, the interference management request may include a request to receive one or more interference parameters from the base station 505 (e.g., information related to one or more targets, etc.).

At 525, the base station 505 may determine a UE measurement configuration for interference management. In some cases, the base station 505 may determine to implement passive or active interference management. At 530, the base station 105 may transmit a measurement configuration to the communications devices 515. In some cases, the measurement configuration may be transmitted in a RRC signaling, in a MAC-CE, in DCI, in CV2X signaling, or any combinations thereof. At 535, the first communications device 515-a may determine radar transmit parameters and measurement time windows for a first stage and a second stage of the measurement procedure. Likewise, at 540, the second communications device 515-b may determine radar transmit parameters and measurement time windows for the first stage and second stage of the measurement procedure.

At 545, as part of the first stage measurement procedure, the first communications device 515-a may transmit a first radar transmission. At 550, as part of the first stage measurement procedure, the second communications device 515-b may measure radar measurement parameters, and generate an associated measurement report. At 555, as part of the second stage measurement procedure, the second communications device 515-b may transmit a second radar transmission. At 560, as part of the second stage measurement procedure, the first communications device 515-a may measure radar measurement parameters, and generate an associated measurement report. At 565, the first communications device 515-a may transmit its measurement report to the base station 505, and at 570 the second communications device 515-b may transmit its measurement report to the base station 505. The base station 505 may determine radar communications parameters based on the measurement reports, in accordance with techniques as discussed herein, and provide the parameters to the communications device 515 for performing radar operations.

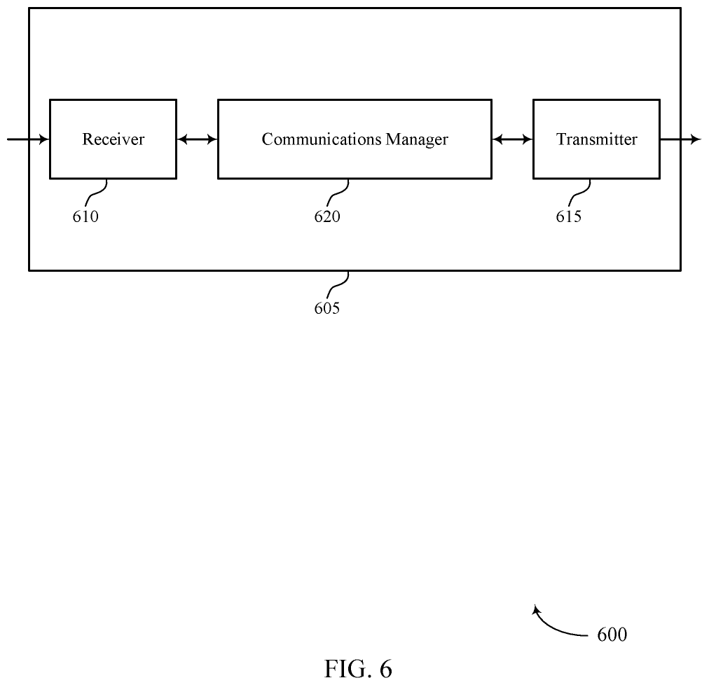

FIG. 6 shows a block diagram 600 of a device 605 that supports interference management techniques for coordinated multi-radar networks in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to interference management techniques for coordinated multi-radar networks). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to interference management techniques for coordinated multi-radar networks). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of interference management techniques for coordinated multi-radar networks as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communication at a UE in accordance with examples as disclosed herein. For example, the communications manager 620 may be configured as or otherwise support a means for receiving, from a first node, signaling that indicates a measurement report configuration, the measurement report configuration indicating a first time period during which the UE is to transmit a first radar signal and a second time period during which the UE is to measure one or more received radar signals. The communications manager 620 may be configured as or otherwise support a means for transmitting the first radar signal during the first time period based on the measurement report configuration. The communications manager 620 may be configured as or otherwise support a means for measuring the one or more received radar signals during the second time period based on the measurement report configuration. The communications manager 620 may be configured as or otherwise support a means for transmitting a measurement report to the first node that includes measurement information for the one or more received radar signals.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for active interference management in coordinated multi-radar networks, in which a first node (e.g., a RSU or base station) and UEs may reduce exposure to interference and may reduce interference in the wireless communications system overall, such that UEs may efficiently detect targets and avoid collisions, enhance overall safety, and enhance system reliability, among other benefits.

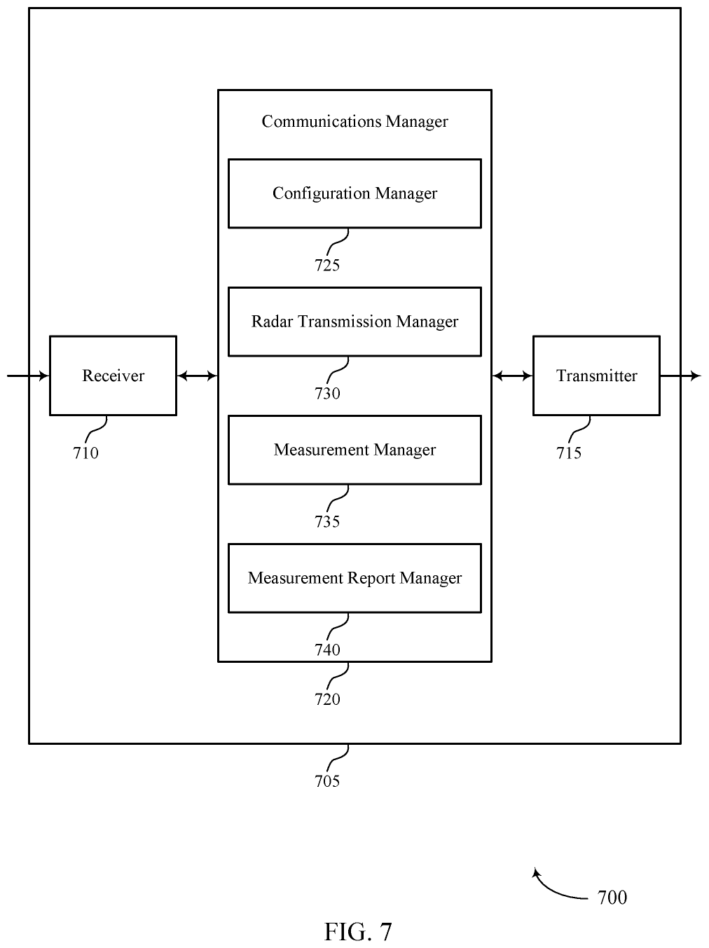

FIG. 7 shows a block diagram 700 of a device 705 that supports interference management techniques for coordinated multi-radar networks in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to interference management techniques for coordinated multi-radar networks). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to interference management techniques for coordinated multi-radar networks). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of interference management techniques for coordinated multi-radar networks as described herein. For example, the communications manager 720 may include a configuration manager 725, a radar transmission manager 730, a measurement manager 735, a measurement report manager 740, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communication at a UE in accordance with examples as disclosed herein. The configuration manager 725 may be configured as or otherwise support a means for receiving, from a first node, signaling that indicates a measurement report configuration, the measurement report configuration indicating a first time period during which the UE is to transmit a first radar signal and a second time period during which the UE is to measure one or more received radar signals. The radar transmission manager 730 may be configured as or otherwise support a means for transmitting the first radar signal during the first time period based on the measurement report configuration. The measurement manager 735 may be configured as or otherwise support a means for measuring the one or more received radar signals during the second time period based on the measurement report configuration. The measurement report manager 740 may be configured as or otherwise support a means for transmitting a measurement report to the first node that includes measurement information for the one or more received radar signals.

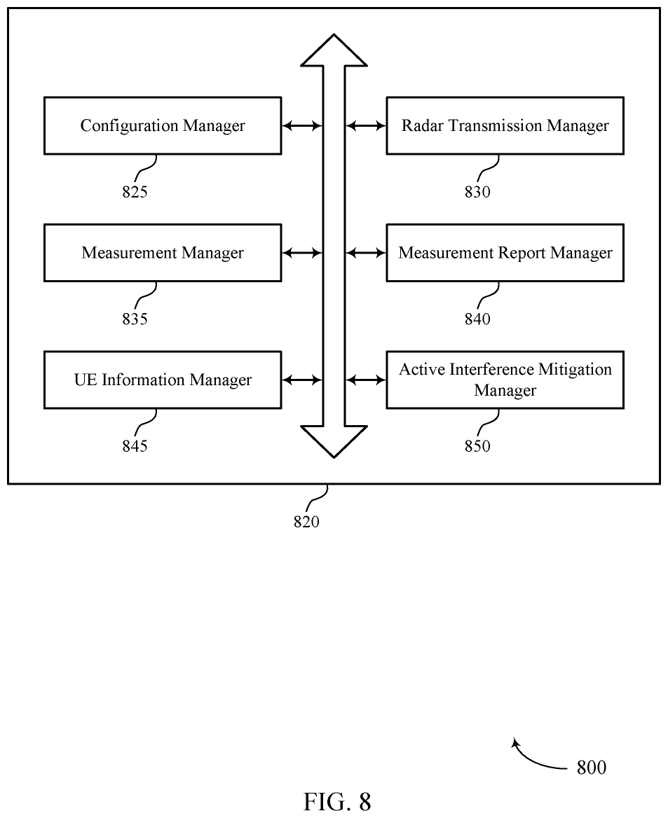

FIG. 8 shows a block diagram 800 of a communications manager 820 that supports interference management techniques for coordinated multi-radar networks in accordance with aspects of the present disclosure. The communications manager 820 may be an example of aspects of a communications manager 620, a communications manager 720, or both, as described herein. The communications manager 820, or various components thereof, may be an example of means for performing various aspects of interference management techniques for coordinated multi-radar networks as described herein. For example, the communications manager 820 may include a configuration manager 825, a radar transmission manager 830, a measurement manager 835, a measurement report manager 840, a UE information manager 845, an active interference mitigation manager 850, or any combination thereof. Each of these components may communicate, directly or indirectly, with one another (e.g., via one or more buses).

The communications manager 820 may support wireless communication at a UE in accordance with examples as disclosed herein. The configuration manager 825 may be configured as or otherwise support a means for receiving, from a first node, signaling that indicates a measurement report configuration, the measurement report configuration indicating a first time period during which the UE is to transmit a first radar signal and a second time period during which the UE is to measure one or more received radar signals. The radar transmission manager 830 may be configured as or otherwise support a means for transmitting the first radar signal during the first time period based on the measurement report configuration. The measurement manager 835 may be configured as or otherwise support a means for measuring the one or more received radar signals during the second time period based on the measurement report configuration. The measurement report manager 840 may be configured as or otherwise support a means for transmitting a measurement report to the first node that includes measurement information for the one or more received radar signals.

In some examples, the radar transmission manager 830 may be configured as or otherwise support a means for receiving, from the first node, radar transmit parameters for radar operation at the UE. In some examples, the radar transmission manager 830 may be configured as or otherwise support a means for activating a radar at the UE based on the radar transmit parameters to detect one or more targets in proximity of the UE. In some examples, the radar transmit parameters provide for interference mitigation in multi-radar cooperative receive processing.

In some examples, the UE information manager 845 may be configured as or otherwise support a means for transmitting, to the first node, an indication of a unique identification of the UE, and one or more of a location, mobility, predicted path, transmit specifications, or performance requirements of the UE.

In some examples, the active interference mitigation manager 850 may be configured as or otherwise support a means for transmitting, to the first node, a request to be included in an active interference management procedure, and an indication of a type of interference information that is requested from the first node.

In some examples, the measurement report configuration indicates one or more parameters that are to be measured at the UE, an accuracy of measurements of the one or more parameters, a data format for the measurement report, transmit parameter specifications and space-time-frequency resources to be used for the measuring the one or more received radar signals during the second time period, or any combinations thereof. In some examples, the measurement report includes one or more of a unique identification of the UE, a location, a UE mobility, a future behavior or path intent of the UE, a radar specification, a received interference-to-noise ratio, one or more detected scatters in a radar heatmap, a relative interfering radar parameter estimation, or any combinations thereof.

In some examples, the radar transmission manager 830 may be configured as or otherwise support a means for receiving, from the first node, radar transmit parameters that indicate a transmit precoder or beamforming parameters to use in radar transmissions, a frequency-modulated continuous wave (FMCW) radar configuration and delay pattern, one or cooperative sensing parameters, or any combinations thereof. In some examples, the radar transmission manager 830 may be configured as or otherwise support a means for transmitting one or more radar signals from the UE based on the radar transmit parameters.

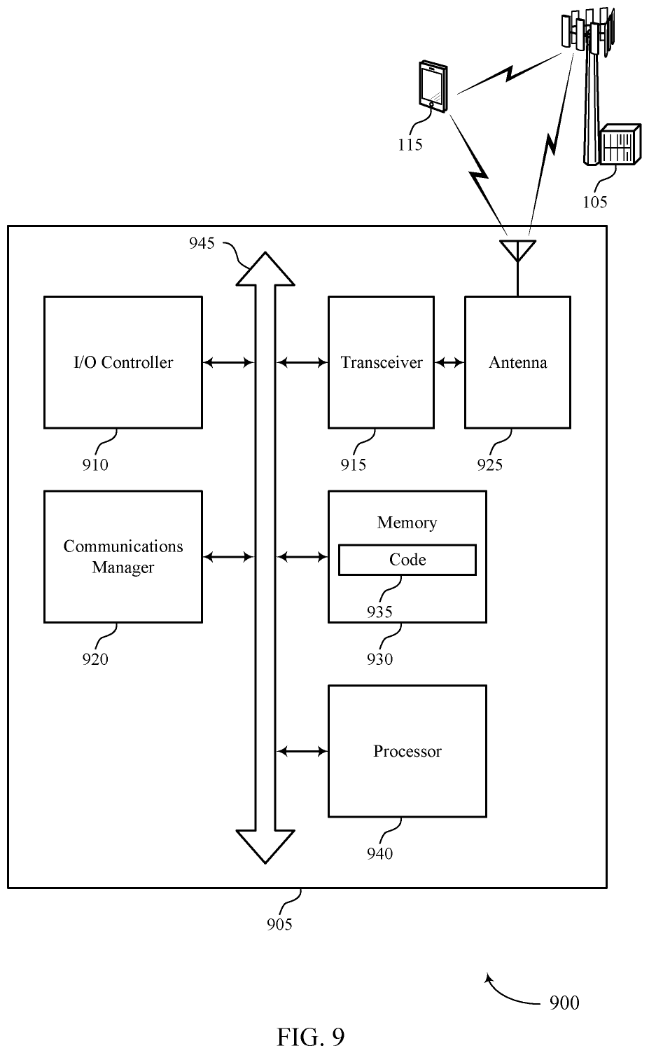

FIG. 9 shows a diagram of a system 900 including a device 905 that supports interference management techniques for coordinated multi-radar networks in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting interference management techniques for coordinated multi-radar networks). For example, the device 905 or a component of the device 905 may include a processor 940 and memory 930 coupled to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for receiving, from a first node, signaling that indicates a measurement report configuration, the measurement report configuration indicating a first time period during which the UE is to transmit a first radar signal and a second time period during which the UE is to measure one or more received radar signals. The communications manager 920 may be configured as or otherwise support a means for transmitting the first radar signal during the first time period based on the measurement report configuration. The communications manager 920 may be configured as or otherwise support a means for measuring the one or more received radar signals during the second time period based on the measurement report configuration. The communications manager 920 may be configured as or otherwise support a means for transmitting a measurement report to the first node that includes measurement information for the one or more received radar signals.

By including or configuring the communications manager 920 in accordance with examples as described herein, the device 905 may support techniques for active interference management in coordinated multi-radar networks, in which a first node (e.g., a RSU or base station) and UEs may reduce exposure to interference and may reduce interference in the wireless communications system overall, such that UEs may efficiently detect targets and avoid collisions, enhance overall safety, and enhance system reliability, among other benefits.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of interference management techniques for coordinated multi-radar networks as described herein, or the processor 940 and the memory 930 may be otherwise configured to perform or support such operations.

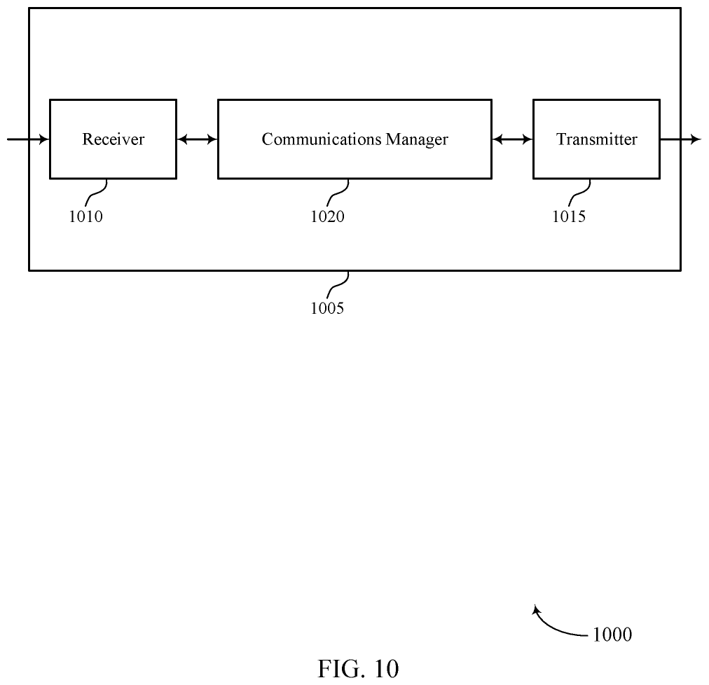

FIG. 10 shows a block diagram 1000 of a device 1005 that supports interference management techniques for coordinated multi-radar networks in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to interference management techniques for coordinated multi-radar networks). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to interference management techniques for coordinated multi-radar networks). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of interference management techniques for coordinated multi-radar networks as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a first node in accordance with examples as disclosed herein. For example, the communications manager 1020 may be configured as or otherwise support a means for determining a measurement configuration for UE measurements for active interference management of a set of multiple radars associated with a set of multiple UEs. The communications manager 1020 may be configured as or otherwise support a means for transmitting, to a first UE, signaling that indicates the measurement configuration that indicates a first time period during which the first UE is to transmit a first radar signal and a second time period during which the first UE is to measure received radar signals. The communications manager 1020 may be configured as or otherwise support a means for transmitting, to a second UE, signaling that indicates the measurement configuration, the measurement configuration indicating that the second UE is to transmit a second radar signal in the second time period and measure received radar signals during the first time period. The communications manager 1020 may be configured as or otherwise support a means for receiving a first measurement report from the first UE and a second measurement report from the second UE. The communications manager 1020 may be configured as or otherwise support a means for determining a first set of radar transmit parameters for the first UE and a second set of radar transmit parameters for the second UE.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for active interference management in coordinated multi-radar networks, in which a first node (e.g., a RSU or base station) and UEs may reduce exposure to interference and may reduce interference in the wireless communications system overall, such that UEs may efficiently detect targets and avoid collisions, enhance overall safety, and enhance system reliability, among other benefits.

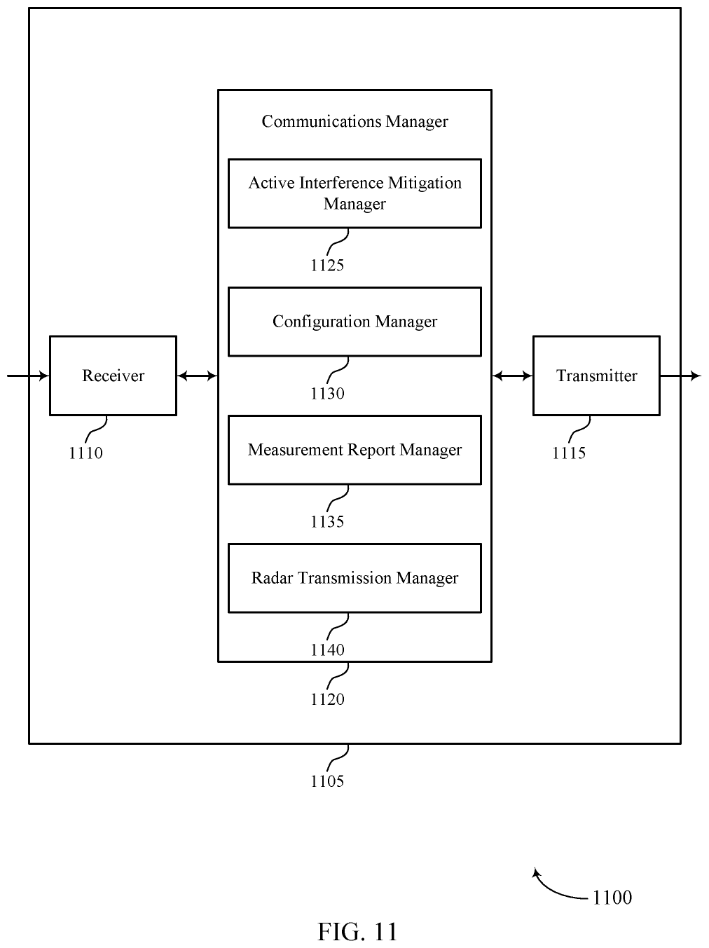

FIG. 11 shows a block diagram 1100 of a device 1105 that supports interference management techniques for coordinated multi-radar networks in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to interference management techniques for coordinated multi-radar networks). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to interference management techniques for coordinated multi-radar networks). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of interference management techniques for coordinated multi-radar networks as described herein. For example, the communications manager 1120 may include an active interference mitigation manager 1125, a configuration manager 1130, a measurement report manager 1135, a radar transmission manager 1140, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communication at a first node in accordance with examples as disclosed herein. The active interference mitigation manager 1125 may be configured as or otherwise support a means for determining a measurement configuration for UE measurements for active interference management of a set of multiple radars associated with a set of multiple UEs. The configuration manager 1130 may be configured as or otherwise support a means for transmitting, to a first UE, signaling that indicates the measurement configuration that indicates a first time period during which the first UE is to transmit a first radar signal and a second time period during which the first UE is to measure received radar signals. The configuration manager 1130 may be configured as or otherwise support a means for transmitting, to a second UE, signaling that indicates the measurement configuration, the measurement configuration indicating that the second UE is to transmit a second radar signal in the second time period and measure received radar signals during the first time period. The measurement report manager 1135 may be configured as or otherwise support a means for receiving a first measurement report from the first UE and a second measurement report from the second UE. The radar transmission manager 1140 may be configured as or otherwise support a means for determining a first set of radar transmit parameters for the first UE and a second set of radar transmit parameters for the second UE.

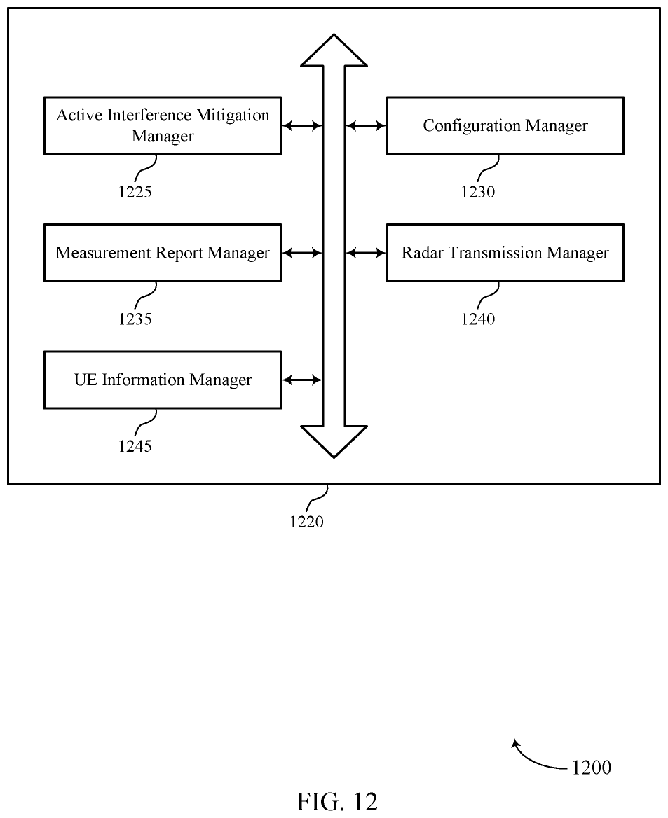

FIG. 12 shows a block diagram 1200 of a communications manager 1220 that supports interference management techniques for coordinated multi-radar networks in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of interference management techniques for coordinated multi-radar networks as described herein. For example, the communications manager 1220 may include an active interference mitigation manager 1225, a configuration manager 1230, a measurement report manager 1235, a radar transmission manager 1240, a UE information manager 1245, or any combination thereof. Each of these components may communicate, directly or indirectly, with one another (e.g., via one or more buses).

The communications manager 1220 may support wireless communication at a first node in accordance with examples as disclosed herein. The active interference mitigation manager 1225 may be configured as or otherwise support a means for determining a measurement configuration for UE measurements for active interference management of a set of multiple radars associated with a set of multiple UEs. The configuration manager 1230 may be configured as or otherwise support a means for transmitting, to a first UE, signaling that indicates the measurement configuration that indicates a first time period during which the first UE is to transmit a first radar signal and a second time period during which the first UE is to measure received radar signals. In some examples, the configuration manager 1230 may be configured as or otherwise support a means for transmitting, to a second UE, signaling that indicates the measurement configuration, the measurement configuration indicating that the second UE is to transmit a second radar signal in the second time period and measure received radar signals during the first time period. The measurement report manager 1235 may be configured as or otherwise support a means for receiving a first measurement report from the first UE and a second measurement report from the second UE. The radar transmission manager 1240 may be configured as or otherwise support a means for determining a first set of radar transmit parameters for the first UE and a second set of radar transmit parameters for the second UE.

In some examples, the active interference mitigation manager 1225 may be configured as or otherwise support a means for transmitting the first set of radar transmit parameters to the first UE and the second set of radar transmit parameters to the second UE, where the radar transmit parameters provide for interference mitigation in multi-radar cooperative receive processing. In some examples, the radar transmit parameters include one or more of a space-time-frequency resource allocation, a transmit precoder, a waveform parameter selection, cooperative sensing and receive processing parameters, or any combinations thereof.

In some examples, the UE information manager 1245 may be configured as or otherwise support a means for receiving, from each of the first UE and the second UE, an indication of a unique identification, and one or more of a location, mobility, predicted path, transmit specifications, or performance requirements of the associated UE.

In some examples, the active interference mitigation manager 1225 may be configured as or otherwise support a means for receiving from each of the first UE and the second UE, a request to be included in active interference management procedures of the first node, and an indication of a type of interference information that is requested.

In some examples, the active interference mitigation manager 1225 may be configured as or otherwise support a means for determining, based on radar specifications and receive requirements of the set of multiple radars associated with the set of multiple UEs, whether to implement coordinated interference management to perform an active interference management procedure or a passive interference management procedure, and where the determining the measurement configuration is performed responsive to determining to implement the active interference management procedure. In some examples, the passive interference management procedure provides time resources and radar transmit parameters for the set of multiple UEs in an absence of measurement reports from the set of multiple UEs. In some examples, the interference management procedure includes a determination of a multi-radar configuration for active radar measurements within a cluster of UEs. In some examples, the passive interference management procedure is implemented based on a congestion level of the set of multiple UEs being below a threshold value, and the active interference management procedure is implemented based on a congestion level of the set of multiple UEs being at or above the threshold value.

In some examples, the first measurement report and the second measurement report each include one or more of a unique identification of the associated UE, a location, a UE mobility, a future behavior or path intent of the associated UE, a radar specification, a received interference-to-noise ratio, one or more detected scatters in a radar heatmap, a relative interfering radar parameter estimation, or any combinations thereof. In some examples, the measurement configuration indicates one or more measurement report parameters and an associated accuracy, a measurement report data format, one or more transmit parameters and space-time-frequency resources to be used while performing measurements, or any combinations thereof. In some examples, the first set of radar transmit parameters and the second set of radar transmit parameters each include an associated time period for use at a corresponding UE. In some examples, the first measurement report and the second measurement report include one or more of a global CSI and interference profile estimate in a range-angle-Doppler domain, a local CSI and interference profile estimate in the range-angle-Doppler domain, a congestion measurement, one or more clutter statistics, a location relative to the first node, a mobility of the associated UE, or any combinations thereof, that are used to determine a prediction of each UE in a cluster of UEs, relative radar transmit parameters, tracking and prediction of one or more scatterers in proximity of one or more UEs, or any combinations thereof. In some examples, the first set of radar transmit parameters and the second set of radar transmit parameters each indicate a transmit precoder or beamforming parameters to use in radar transmissions, a FMCW radar configuration and delay pattern, one or cooperative sensing parameters, or any combinations thereof.

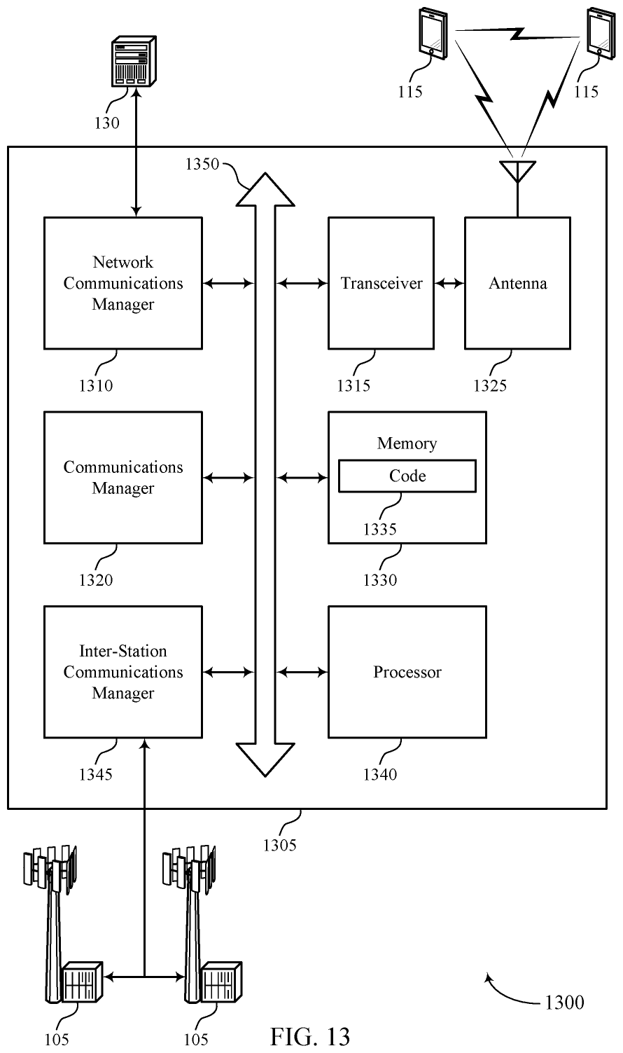

FIG. 13 shows a diagram of a system 1300 including a device 1305 that supports interference management techniques for coordinated multi-radar networks in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting interference management techniques for coordinated multi-radar networks). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communication at a first node in accordance with examples as disclosed herein. For example, the communications manager 1320 may be configured as or otherwise support a means for determining a measurement configuration for UE measurements for active interference management of a set of multiple radars associated with a set of multiple UEs. The communications manager 1320 may be configured as or otherwise support a means for transmitting, to a first UE, signaling that indicates the measurement configuration that indicates a first time period during which the first UE is to transmit a first radar signal and a second time period during which the first UE is to measure received radar signals. The communications manager 1320 may be configured as or otherwise support a means for transmitting, to a second UE, signaling that indicates the measurement configuration, the measurement configuration indicating that the second UE is to transmit a second radar signal in the second time period and measure received radar signals during the first time period. The communications manager 1320 may be configured as or otherwise support a means for receiving a first measurement report from the first UE and a second measurement report from the second UE. The communications manager 1320 may be configured as or otherwise support a means for determining a first set of radar transmit parameters for the first UE and a second set of radar transmit parameters for the second UE.

By including or configuring the communications manager 1320 in accordance with examples as described herein, the device 1305 may support techniques for active interference management in coordinated multi-radar networks, in which a first node (e.g., a RSU or base station) and UEs may reduce exposure to interference and may reduce interference in the wireless communications system overall, such that UEs may efficiently detect targets and avoid collisions, enhance overall safety, and enhance system reliability, among other benefits.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of interference management techniques for coordinated multi-radar networks as described herein, or the processor 1340 and the memory 1330 may be otherwise configured to perform or support such operations.

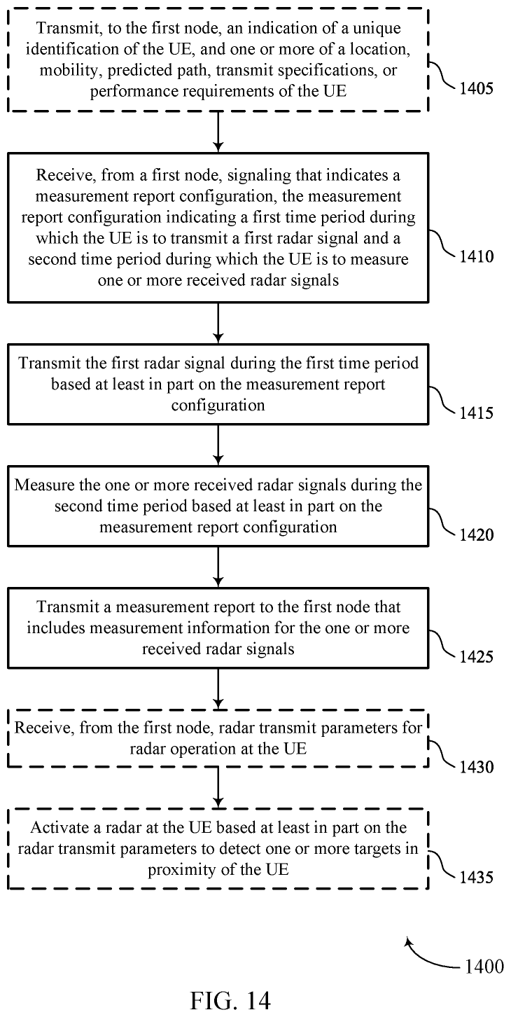

FIG. 14 shows a flowchart illustrating a method 1400 that supports interference management techniques for coordinated multi-radar networks in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

Optionally, at 1405, the method may include transmitting, to the first node, an indication of a unique identification of the UE, and one or more of a location, mobility, predicted path, transmit specifications, or performance requirements of the UE. The operations of 1405 may be performed in accordance with examples as disclosed herein. In some examples, aspects of the operations of 1405 may be performed by a UE information manager 845 as described with reference to FIG. 8.

At 1410, the method may include receiving, from a first node, signaling that indicates a measurement report configuration, the measurement report configuration indicating a first time period during which the UE is to transmit a first radar signal and a second time period during which the UE is to measure one or more received radar signals. The operations of 1410 may be performed in accordance with examples as disclosed herein. In some examples, aspects of the operations of 1410 may be performed by a configuration manager 825 as described with reference to FIG. 8.

At 1415, the method may include transmitting the first radar signal during the first time period based on the measurement report configuration. The operations of 1415 may be performed in accordance with examples as disclosed herein. In some examples, aspects of the operations of 1415 may be performed by a radar transmission manager 830 as described with reference to FIG. 8.

At 1420, the method may include measuring the one or more received radar signals during the second time period based on the measurement report configuration. The operations of 1420 may be performed in accordance with examples as disclosed herein. In some examples, aspects of the operations of 1420 may be performed by a measurement manager 835 as described with reference to FIG. 8.

At 1425, the method may include transmitting a measurement report to the first node that includes measurement information for the one or more received radar signals. The operations of 1425 may be performed in accordance with examples as disclosed herein. In some examples, aspects of the operations of 1425 may be performed by a measurement report manager 840 as described with reference to FIG. 8.

Optionally, at 1430, the method may include receiving, from the first node, radar transmit parameters for radar operation at the UE. The operations of 1430 may be performed in accordance with examples as disclosed herein. In some examples, aspects of the operations of 1430 may be performed by a radar transmission manager 830 as described with reference to FIG. 8.

Optionally, at 1435, the method may include activating a radar at the UE based on the radar transmit parameters to detect one or more targets in proximity of the UE. The operations of 1435 may be performed in accordance with examples as disclosed herein. In some examples, aspects of the operations of 1435 may be performed by a radar transmission manager 830 as described with reference to FIG. 8.

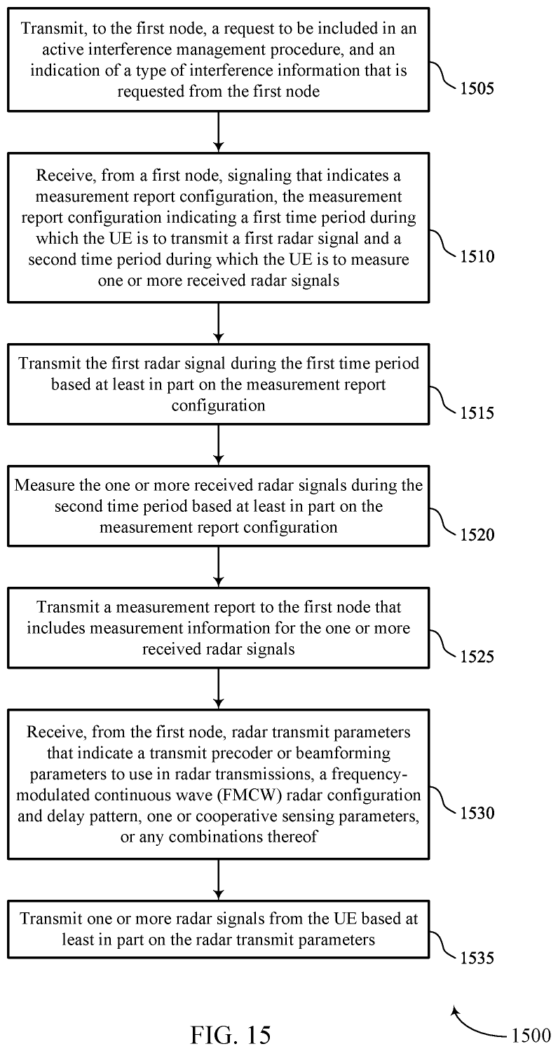

FIG. 15 shows a flowchart illustrating a method 1500 that supports interference management techniques for coordinated multi-radar networks in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally or alternatively, the UE may perform aspects of the described functions using special-purpose hardware.

At 1505, the method may include transmitting, to the first node, a request to be included in an active interference management procedure, and an indication of a type of interference information that is requested from the first node. The operations of 1505 may be performed in accordance with examples as disclosed herein. In some examples, aspects of the operations of 1505 may be performed by an active interference mitigation manager 850 as described with reference to FIG. 8.

At 1510, the method may include receiving, from a first node, signaling that indicates a measurement report configuration, the measurement report configuration indicating a first time period during which the UE is to transmit a first radar signal and a second time period during which the UE is to measure one or more received radar signals. The operations of 1510 may be performed in accordance with examples as disclosed herein. In some examples, aspects of the operations of 1510 may be performed by a configuration manager 825 as described with reference to FIG. 8.

At 1515, the method may include transmitting the first radar signal during the first time period based on the measurement report configuration. The operations of 1515 may be performed in accordance with examples as disclosed herein. In some examples, aspects of the operations of 1515 may be performed by a radar transmission manager 830 as described with reference to FIG. 8.

At 1520, the method may include measuring the one or more received radar signals during the second time period based on the measurement report configuration. The operations of 1520 may be performed in accordance with examples as disclosed herein. In some examples, aspects of the operations of 1520 may be performed by a measurement manager 835 as described with reference to FIG. 8.

At 1525, the method may include transmitting a measurement report to the first node that includes measurement information for the one or more received radar signals. The operations of 1525 may be performed in accordance with examples as disclosed herein. In some examples, aspects of the operations of 1525 may be performed by a measurement report manager 840 as described with reference to FIG. 8.

At 1530, the method may include receiving, from the first node, radar transmit parameters that indicate a transmit precoder or beamforming parameters to use in radar transmissions, a frequency-modulated continuous wave (FMCW) radar configuration and delay pattern, one or cooperative sensing parameters, or any combinations thereof. The operations of 1530 may be performed in accordance with examples as disclosed herein. In some examples, aspects of the operations of 1530 may be performed by a radar transmission manager 830 as described with reference to FIG. 8.

At 1535, the method may include transmitting one or more radar signals from the UE based on the radar transmit parameters. The operations of 1535 may be performed in accordance with examples as disclosed herein. In some examples, aspects of the operations of 1535 may be performed by a radar transmission manager 830 as described with reference to FIG. 8.

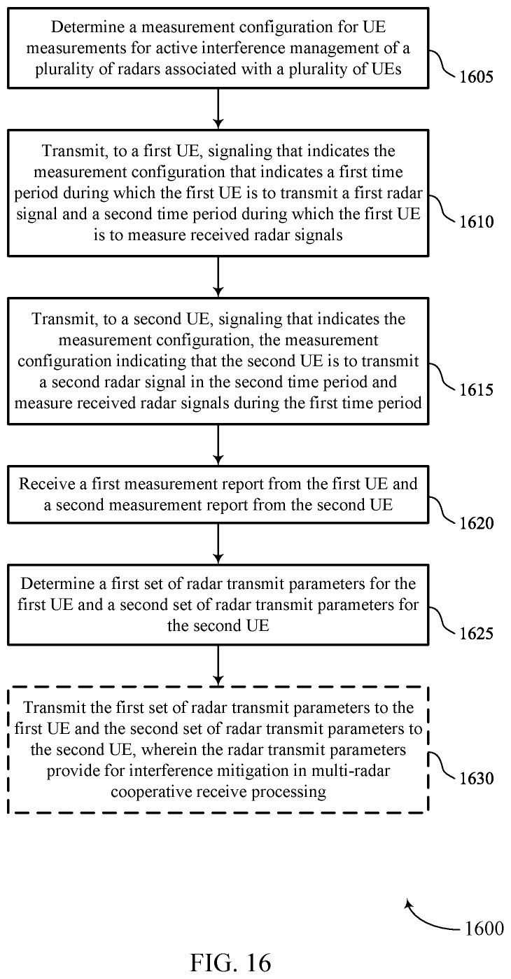

FIG. 16 shows a flowchart illustrating a method 1600 that supports interference management techniques for coordinated multi-radar networks in accordance with aspects of the present disclosure. The operations of the method 1600 may be implemented by a base station or its components as described herein. For example, the operations of the method 1600 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1605, the method may include determining a measurement configuration for UE measurements for active interference management of a set of multiple radars associated with a set of multiple UEs. The operations of 1605 may be performed in accordance with examples as disclosed herein. In some examples, aspects of the operations of 1605 may be performed by an active interference mitigation manager 1225 as described with reference to FIG. 12.

At 1610, the method may include transmitting, to a first UE, signaling that indicates the measurement configuration that indicates a first time period during which the first UE is to transmit a first radar signal and a second time period during which the first UE is to measure received radar signals. The operations of 1610 may be performed in accordance with examples as disclosed herein. In some examples, aspects of the operations of 1610 may be performed by a configuration manager 1230 as described with reference to FIG. 12.

At 1615, the method may include transmitting, to a second UE, signaling that indicates the measurement configuration, the measurement configuration indicating that the second UE is to transmit a second radar signal in the second time period and measure received radar signals during the first time period. The operations of 1615 may be performed in accordance with examples as disclosed herein. In some examples, aspects of the operations of 1615 may be performed by a configuration manager 1230 as described with reference to FIG. 12.

At 1620, the method may include receiving a first measurement report from the first UE and a second measurement report from the second UE. The operations of 1620 may be performed in accordance with examples as disclosed herein. In some examples, aspects of the operations of 1620 may be performed by a measurement report manager 1235 as described with reference to FIG. 12.

At 1625, the method may include determining a first set of radar transmit parameters for the first UE and a second set of radar transmit parameters for the second UE. The operations of 1625 may be performed in accordance with examples as disclosed herein. In some examples, aspects of the operations of 1625 may be performed by a radar transmission manager 1240 as described with reference to FIG. 12.

Optionally, at 1630, the method may include transmitting the first set of radar transmit parameters to the first UE and the second set of radar transmit parameters to the second UE, where the radar transmit parameters provide for interference mitigation in multi-radar cooperative receive processing. The operations of 1630 may be performed in accordance with examples as disclosed herein. In some examples, aspects of the operations of 1630 may be performed by an active interference mitigation manager 1225 as described with reference to FIG. 12.

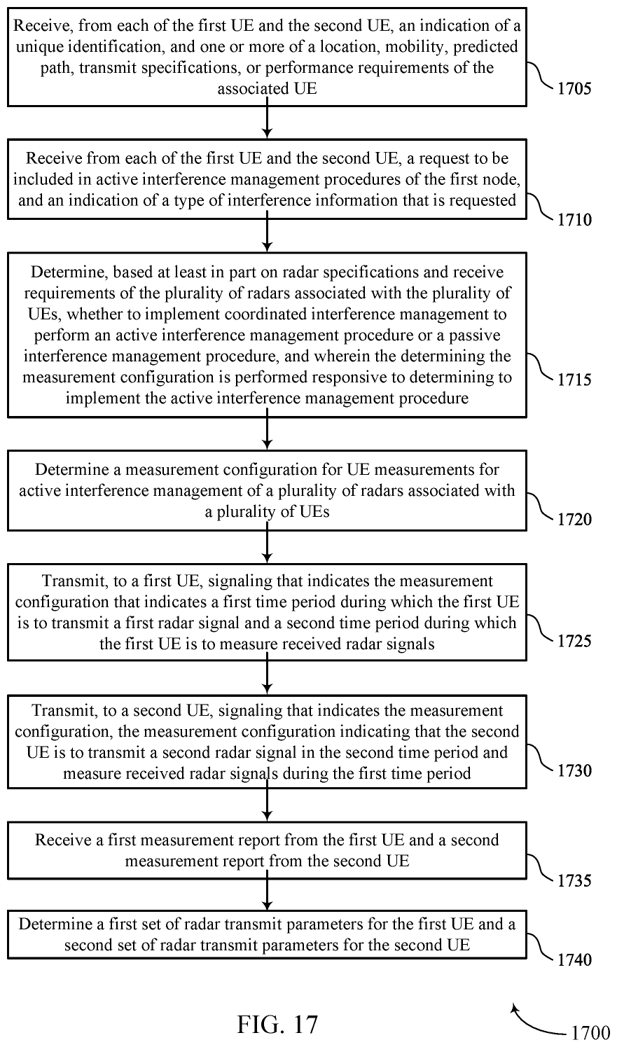

FIG. 17 shows a flowchart illustrating a method 1700 that supports interference management techniques for coordinated multi-radar networks in accordance with aspects of the present disclosure. The operations of the method 1700 may be implemented by a base station or its components as described herein. For example, the operations of the method 1700 may be performed by a base station 105 as described with reference to FIGS. 1 through 5 and 10 through 13. In some examples, a base station may execute a set of instructions to control the functional elements of the base station to perform the described functions. Additionally or alternatively, the base station may perform aspects of the described functions using special-purpose hardware.

At 1705, the method may include receiving, from each of the first UE and the second UE, an indication of a unique identification, and one or more of a location, mobility, predicted path, transmit specifications, or performance requirements of the associated UE. The operations of 1705 may be performed in accordance with examples as disclosed herein. In some examples, aspects of the operations of 1705 may be performed by a UE information manager 1245 as described with reference to FIG. 12.

At 1710, the method may include receiving from each of the first UE and the second UE, a request to be included in active interference management procedures of the first node, and an indication of a type of interference information that is requested. The operations of 1710 may be performed in accordance with examples as disclosed herein. In some examples, aspects of the operations of 1710 may be performed by an active interference mitigation manager 1225 as described with reference to FIG. 12.

At 1715, the method may include determining, based on radar specifications and receive requirements of the set of multiple radars associated with the set of multiple UEs, whether to implement coordinated interference management to perform an active interference management procedure or a passive interference management procedure, and where the determining the measurement configuration is performed responsive to determining to implement the active interference management procedure. The operations of 1715 may be performed in accordance with examples as disclosed herein. In some examples, aspects of the operations of 1715 may be performed by an active interference mitigation manager 1225 as described with reference to FIG. 12.

At 1720, the method may include determining a measurement configuration for UE measurements for active interference management of a set of multiple radars associated with a set of multiple UEs. The operations of 1720 may be performed in accordance with examples as disclosed herein. In some examples, aspects of the operations of 1720 may be performed by an active interference mitigation manager 1225 as described with reference to FIG. 12.

At 1725, the method may include transmitting, to a first UE, signaling that indicates the measurement configuration that indicates a first time period during which the first UE is to transmit a first radar signal and a second time period during which the first UE is to measure received radar signals. The operations of 1725 may be performed in accordance with examples as disclosed herein. In some examples, aspects of the operations of 1725 may be performed by a configuration manager 1230 as described with reference to FIG. 12.

At 1730, the method may include transmitting, to a second UE, signaling that indicates the measurement configuration, the measurement configuration indicating that the second UE is to transmit a second radar signal in the second time period and measure received radar signals during the first time period. The operations of 1730 may be performed in accordance with examples as disclosed herein. In some examples, aspects of the operations of 1730 may be performed by a configuration manager 1230 as described with reference to FIG. 12.

At 1735, the method may include receiving a first measurement report from the first UE and a second measurement report from the second UE. The operations of 1735 may be performed in accordance with examples as disclosed herein. In some examples, aspects of the operations of 1735 may be performed by a measurement report manager 1235 as described with reference to FIG. 12.

At 1740, the method may include determining a first set of radar transmit parameters for the first UE and a second set of radar transmit parameters for the second UE. The operations of 1740 may be performed in accordance with examples as disclosed herein. In some examples, aspects of the operations of 1740 may be performed by a radar transmission manager 1240 as described with reference to FIG. 12.

The following provides an overview of aspects of the present disclosure:

Aspect 1: A method for wireless communication at a UE, comprising: receiving, from a first node, signaling that indicates a measurement report configuration, the measurement report configuration indicating a first time period during which the UE is to transmit a first radar signal and a second time period during which the UE is to measure one or more received radar signals; transmitting the first radar signal during the first time period based at least in part on the measurement report configuration; measuring the one or more received radar signals during the second time period based at least in part on the measurement report configuration; and transmitting a measurement report to the first node that includes measurement information for the one or more received radar signals.

Aspect 2: The method of aspect 1, further comprising: receiving, from the first node, radar transmit parameters for radar operation at the UE; and activating a radar at the UE based at least in part on the radar transmit parameters to detect one or more targets in proximity of the UE.

Aspect 3: The method of aspect 2, wherein the radar transmit parameters provide for interference mitigation in multi-radar cooperative receive processing.

Aspect 4: The method of any of aspects 1 through 3, further comprising: transmitting, to the first node, an indication of a unique identification of the UE, and one or more of a location, mobility, predicted path, transmit specifications, or performance requirements of the UE.

Aspect 5: The method of any of aspects 1 through 4, further comprising: transmitting, to the first node, a request to be included in an active interference management procedure, and an indication of a type of interference information that is requested from the first node.

Aspect 6: The method of any of aspects 1 through 5, wherein the measurement report configuration indicates one or more parameters that are to be measured at the UE, an accuracy of measurements of the one or more parameters, a data format for the measurement report, transmit parameter specifications and space-time-frequency resources to be used for the measuring the one or more received radar signals during the second time period, or any combinations thereof.

Aspect 7: The method of any of aspects 1 through 6, wherein the measurement report includes one or more of a unique identification of the UE, a location, a UE mobility, a future behavior or path intent of the UE, a radar specification, a received interference-to-noise ratio, one or more detected scatters in a radar heatmap, a relative interfering radar parameter estimation, or any combinations thereof.

Aspect 8: The method of any of aspects 1 through 7, further comprising: receiving, from the first node, radar transmit parameters that indicate a transmit precoder or beamforming parameters to use in radar transmissions, a frequency-modulated continuous wave (FMCW) radar configuration and delay pattern, one or cooperative sensing parameters, or any combinations thereof; and transmitting one or more radar signals from the UE based at least in part on the radar transmit parameters.

Aspect 9: A method for wireless communication at a first node, comprising: determining a measurement configuration for UE measurements for active interference management of a plurality of radars associated with a plurality of UEs; transmitting, to a first UE, signaling that indicates the measurement configuration that indicates a first time period during which the first UE is to transmit a first radar signal and a second time period during which the first UE is to measure received radar signals; transmitting, to a second UE, signaling that indicates the measurement configuration, the measurement configuration indicating that the second UE is to transmit a second radar signal in the second time period and measure received radar signals during the first time period; receiving a first measurement report from the first UE and a second measurement report from the second UE; and determining a first set of radar transmit parameters for the first UE and a second set of radar transmit parameters for the second UE.

Aspect 10: The method of aspect 9, further comprising: transmitting the first set of radar transmit parameters to the first UE and the second set of radar transmit parameters to the second UE, wherein the radar transmit parameters provide for interference mitigation in multi-radar cooperative receive processing.

Aspect 11: The method of aspect 10, wherein the radar transmit parameters include one or more of a space-time-frequency resource allocation, a transmit precoder, a waveform parameter selection, cooperative sensing and receive processing parameters, or any combinations thereof.

Aspect 12: The method of any of aspects 9 through 11, further comprising: receiving, from each of the first UE and the second UE, an indication of a unique identification, and one or more of a location, mobility, predicted path, transmit specifications, or performance requirements of the associated UE.

Aspect 13: The method of any of aspects 9 through 12, further comprising: receiving from each of the first UE and the second UE, a request to be included in active interference management procedures of the first node, and an indication of a type of interference information that is requested.

Aspect 14: The method of any of aspects 9 through 13, further comprising: determining, based at least in part on radar specifications and receive requirements of the plurality of radars associated with the plurality of UEs, whether to implement coordinated interference management to perform an active interference management procedure or a passive interference management procedure, and wherein the determining the measurement configuration is performed responsive to determining to implement the active interference management procedure.

Aspect 15: The method of aspect 14, wherein the passive interference management procedure provides time resources and radar transmit parameters for the plurality of UEs in an absence of measurement reports from the plurality of UEs.

Aspect 16: The method of any of aspects 14 through 15, wherein the interference management procedure includes a determination of a multi-radar configuration for active radar measurements within a cluster of UEs.

Aspect 17: The method of any of aspects 14 through 16, wherein the passive interference management procedure is implemented based on a congestion level of the plurality of UEs being below a threshold value, and the active interference management procedure is implemented based on a congestion level of the plurality of UEs being at or above the threshold value.

Aspect 18: The method of any of aspects 9 through 17, wherein the first measurement report and the second measurement report each include one or more of a unique identification of the associated UE, a location, a UE mobility, a future behavior or path intent of the associated UE, a radar specification, a received interference-to-noise ratio, one or more detected scatters in a radar heatmap, a relative interfering radar parameter estimation, or any combinations thereof.

Aspect 19: The method of any of aspects 9 through 18, wherein the measurement configuration indicates one or more measurement report parameters and an associated accuracy, a measurement report data format, one or more transmit parameters and space-time-frequency resources to be used while performing measurements, or any combinations thereof.

Aspect 20: The method of any of aspects 9 through 19, wherein the first set of radar transmit parameters and the second set of radar transmit parameters each include an associated time period for use at a corresponding UE.

Aspect 21: The method of any of aspects 9 through 20, wherein the first measurement report and the second measurement report include one or more of a global CSI and interference profile estimate in a range-angle-Doppler domain, a local CSI and interference profile estimate in the range-angle-Doppler domain, a congestion measurement, one or more clutter statistics, a location relative to the first node, a mobility of the associated UE, or any combinations thereof, that are used to determine a prediction of each UE in a cluster of UEs, relative radar transmit parameters, tracking and prediction of one or more scatterers in proximity of one or more UEs, or any combinations thereof.

Aspect 22: The method of any of aspects 9 through 21, wherein the first set of radar transmit parameters and the second set of radar transmit parameters each indicate a transmit precoder or beamforming parameters to use in radar transmissions, a frequency-modulated continuous wave (FMCW) radar configuration and delay pattern, one or cooperative sensing parameters, or any combinations thereof.

Aspect 23: An apparatus for wireless communication at a UE, comprising a processor; memory coupled with the processor; and instructions stored in the memory and executable by the processor to cause the apparatus to perform a method of any of aspects 1 through 8.

Aspect 24: An apparatus for wireless communication at a UE, comprising at least one means for performing a method of any of aspects 1 through 8.

Aspect 25: A non-transitory computer-readable medium storing code for wireless communication at a UE, the code comprising instructions executable by a processor to perform a method of any of aspects 1 through 8.

Aspect 26: An apparatus for wireless communication at a first node, comprising a processor; memory coupled with the processor; and instructions stored in the memory and executable by the processor to cause the apparatus to perform a method of any of aspects 9 through 22.

Aspect 27: An apparatus for wireless communication at a first node, comprising at least one means for performing a method of any of aspects 9 through 22.

Aspect 28: A non-transitory computer-readable medium storing code for wireless communication at a first node, the code comprising instructions executable by a processor to perform a method of any of aspects 9 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving, from a first node, signaling that indicates a measurement report configuration, the measurement report configuration indicating a first time period during which the UE is to transmit a first radar signal and a second time period during which the UE is to measure one or more received radar signals;
transmitting the first radar signal during the first time period based at least in part on the measurement report configuration;
measuring the one or more received radar signals during the second time period based at least in part on the measurement report configuration; and
transmitting a measurement report to the first node that includes measurement information for the one or more received radar signals.

2. The method of claim 1, further comprising:
receiving, from the first node, radar transmit parameters for radar operation at the UE; and
activating a radar at the UE based at least in part on the radar transmit parameters to detect one or more targets in proximity of the UE.

3. The method of claim 2, wherein the radar transmit parameters provide for interference mitigation in multi-radar cooperative receive processing.

4. The method of claim 1, further comprising:
transmitting, to the first node, an indication of a unique identification of the UE, and one or more of a location, mobility, predicted path, transmit specifications, or performance requirements of the UE.

5. The method of claim 1, further comprising:
transmitting, to the first node, a request to be included in an active interference management procedure, and an indication of a type of interference information that is requested from the first node.

6. The method of claim 1, wherein the measurement report configuration indicates one or more parameters that are to be measured at the UE, an accuracy of measurements of the one or more parameters, a data format for the measurement report, transmit parameter specifications and space-time-frequency resources to be used for the measuring the one or more received radar signals during the second time period, or any combinations thereof.

7. The method of claim 1, wherein the measurement report includes one or more of a unique identification of the UE, a location, a UE mobility, a future behavior or path intent of the UE, a radar specification, a received interference-to-noise ratio, one or more detected scatters in a radar heatmap, a relative interfering radar parameter estimation, or any combinations thereof.

8. The method of claim 1, further comprising:
receiving, from the first node, radar transmit parameters that indicate a transmit precoder or beamforming parameters to use in radar transmissions, a frequency-modulated continuous wave (FMCW) radar configuration and delay pattern, one or cooperative sensing parameters, or any combinations thereof; and
transmitting one or more radar signals from the UE based at least in part on the radar transmit parameters.

9. A method for wireless communication at a first node, comprising:
determining a measurement configuration for user equipment (UE) measurements for active interference management of a plurality of radars associated with a plurality of UEs;
transmitting, to a first UE, signaling that indicates the measurement configuration that indicates a first time period during which the first UE is to transmit a first radar signal and a second time period during which the first UE is to measure received radar signals;
transmitting, to a second UE, signaling that indicates the measurement configuration, the measurement configuration indicating that the second UE is to transmit a second radar signal in the second time period and measure received radar signals during the first time period;
receiving a first measurement report from the first UE and a second measurement report from the second UE; and
determining a first set of radar transmit parameters for the first UE and a second set of radar transmit parameters for the second UE.

10. The method of claim 9, further comprising:
transmitting the first set of radar transmit parameters to the first UE and the second set of radar transmit parameters to the second UE, wherein the radar transmit parameters provide for interference mitigation in multi-radar cooperative receive processing.

11. The method of claim 10, wherein the radar transmit parameters include one or more of a space-time-frequency resource allocation, a transmit precoder, a waveform parameter selection, cooperative sensing and receive processing parameters, or any combinations thereof.

12. The method of claim 9, further comprising:
receiving, from each of the first UE and the second UE, an indication of a unique identification, and one or more of a location, mobility, predicted path, transmit specifications, or performance requirements of the associated UE.

13. The method of claim 9, further comprising:
receiving from each of the first UE and the second UE, a request to be included in active interference management procedures of the first node, and an indication of a type of interference information that is requested.

14. The method of claim 9, further comprising:
determining, based at least in part on radar specifications and receive requirements of the plurality of radars associated with the plurality of UEs, whether to implement coordinated interference management to perform an active interference management procedure or a passive interference management procedure, and wherein the determining the measurement configuration is performed responsive to determining to implement the active interference management procedure.

15. The method of claim 14, wherein the passive interference management procedure provides time resources and radar transmit parameters for the plurality of UEs in an absence of measurement reports from the plurality of UEs.

16. The method of claim 14, wherein the interference management procedure includes a determination of a multi-radar configuration for active radar measurements within a cluster of UEs.

17. The method of claim 14, wherein the passive interference management procedure is implemented based on a congestion level of the plurality of UEs being below a threshold value, and the active interference management procedure is implemented based on a congestion level of the plurality of UEs being at or above the threshold value.

18. The method of claim 9, wherein the first measurement report and the second measurement report each include one or more of a unique identification of the associated UE, a location, a UE mobility, a future behavior or path intent of the associated UE, a radar specification, a received interference-to-noise ratio, one or more detected scatters in a radar heatmap, a relative interfering radar parameter estimation, or any combinations thereof.

19. The method of claim 9, wherein the measurement configuration indicates one or more measurement report parameters and an associated accuracy, a measurement report data format, one or more transmit parameters and space-time-frequency resources to be used while performing measurements, or any combinations thereof.

20. The method of claim 9, wherein the first set of radar transmit parameters and the second set of radar transmit parameters each include an associated time period for use at a corresponding UE.

21. The method of claim 9, wherein the first measurement report and the second measurement report include one or more of a global channel state information (CSI) and interference profile estimate in a range-angle-Doppler domain, a local CSI and interference profile estimate in the range-angle-Doppler domain, a congestion measurement, one or more clutter statistics, a location relative to the first node, a mobility of the associated UE, or any combinations thereof, that are used to determine a prediction of each UE in a cluster of UEs, relative radar transmit parameters, tracking and prediction of one or more scatterers in proximity of one or more UEs, or any combinations thereof.

22. The method of claim 9, wherein the first set of radar transmit parameters and the second set of radar transmit parameters each indicate a transmit precoder or beamforming parameters to use in radar transmissions, a frequency-modulated continuous wave (FMCW) radar configuration and delay pattern, one or cooperative sensing parameters, or any combinations thereof.

23. An apparatus for wireless communication at a user equipment (UE), comprising:
a processor;
memory coupled with the processor; and
instructions stored in the memory and executable by the processor to cause the apparatus to:
receive, from a first node, signaling that indicates a measurement report configuration, the measurement report configuration indicating a first time period during which the UE is to transmit a first radar signal and a second time period during which the UE is to measure one or more received radar signals;
transmit the first radar signal during the first time period based at least in part on the measurement report configuration;
measure the one or more received radar signals during the second time period based at least in part on the measurement report configuration; and
transmit a measurement report to the first node that includes measurement information for the one or more received radar signals.

24. The apparatus of claim 23, wherein the instructions are further executable by the processor to cause the apparatus to:
receive, from the first node, radar transmit parameters for radar operation at the UE; and
activate a radar at the UE based at least in part on the radar transmit parameters to detect one or more targets in proximity of the UE.

25. The apparatus of claim 23, wherein the instructions are further executable by the processor to cause the apparatus to:
transmit, to the first node, a request to be included in an active interference management procedure, and an indication of a type of interference information that is requested from the first node.

26. An apparatus for wireless communication at a first node, comprising:
a processor;
memory coupled with the processor; and
instructions stored in the memory and executable by the processor to cause the apparatus to:
determine a measurement configuration for user equipment (UE) measurements for active interference management of a plurality of radars associated with a plurality of UEs;
transmit, to a first UE, signaling that indicates the measurement configuration that indicates a first time period during which the first UE is to transmit a first radar signal and a second time period during which the first UE is to measure received radar signals;
transmit, to a second UE, signaling that indicates the measurement configuration, the measurement configuration indicating that the second UE is to transmit a second radar signal in the second time period and measure received radar signals during the first time period;
receive a first measurement report from the first UE and a second measurement report from the second UE; and
determine a first set of radar transmit parameters for the first UE and a second set of radar transmit parameters for the second UE.

27. The apparatus of claim 26, wherein the instructions are further executable by the processor to cause the apparatus to:
transmit the first set of radar transmit parameters to the first UE and the second set of radar transmit parameters to the second UE, wherein the radar transmit parameters provide for interference mitigation in multi-radar cooperative receive processing.

28. The apparatus of claim 27, wherein the radar transmit parameters include one or more of a space-time-frequency resource allocation, a transmit precoder, a waveform parameter selection, cooperative sensing and receive processing parameters, or any combinations thereof.

29. The apparatus of claim 26, wherein the instructions are further executable by the processor to cause the apparatus to:
receive from each of the first UE and the second UE, a request to be included in active interference management procedures of the first node, and an indication of a type of interference information that is requested.

30. The apparatus of claim 26, wherein the instructions are further executable by the processor to cause the apparatus to:
determine, based at least in part on radar specifications and receive requirements of the plurality of radars associated with the plurality of UEs, whether to implement coordinated interference management to perform an active interference management procedure or a passive interference management procedure, and wherein the determining the measurement configuration is performed responsive to determining to implement the active interference management procedure.
